(19) United States
(12) Patent Application Publication
(10) Pub. No.: US 2014/0225030 A1
(43) Pub. Date: Aug. 14, 2014

(54) METHOD OF CONTROLLING THE CRYSTALLINITY OF A SILICON POWDER

(71) Applicants: Hemlock Semiconductor Corporation, Hemlock, MI (US); Dow Corning Corporation, Midland, MI (US)

(72) Inventors: Max Dehtiar, Saginaw, MI (US); William Herron, Midland, MI (US); Byung K. Hwang, Midland, MI (US); Jennifer Larimer, Flushing, MI (US); Mark Schrauben, Alma, MI (US); Raymond Tabler, Midland, MI (US)

(21) Appl. No.: 14/179,921

(22) Filed: Feb. 13, 2014

Related U.S. Application Data
(63) Continuation-in-part of application No. PCT/US2012/050779, filed on Aug. 14, 2012.

(51) Int. Cl. C01B 33/027

(52) U.S. Cl. CPC C01B 33/027
USPC 252/182.1

(57) ABSTRACT

A method of controlling the crystallinity of a silicon powder may include heating a reactor to a temperature of no more than 650° C., and flowing a feed gas comprising silane and a carrier gas into the reactor at a molar gas flux of from about 5 mol/min/m² to about 25 mol/min/m². The silane decomposes to form a silicon powder having a controlled crystallinity and comprising non-crystalline silicon. According to another embodiment, a method of controlling the crystallinity of a silicon powder may include flowing a feed gas comprising silane and a carrier gas into a heated reactor at a molar gas flux of from about 5 mol/min/m² to about 25 mol/min/m², and maintaining an internal reactor pressure of about 2 atm or less during the flowing of the feed gas into the heated reactor. The silane decomposes to form a silicon powder having a controlled crystallinity and comprising non-crystalline silicon.

### RELATED APPLICATIONS

The present patent document is a continuation-in-part (CIP) of International Patent Application PCT/US2012/050779, filed on Aug. 14, 2012, which claims the benefit of the filing date under 35 U.S.C. §119(e) of U.S. Provisional Patent Application Ser. No. 61/523,658, filed on Aug. 15, 2011. Both patent applications are hereby incorporated by reference in their entirety.

### TECHNICAL FIELD

The present disclosure relates generally to powder processing and more specifically to a method of controlling the crystallinity of a silicon powder.

### BACKGROUND

Over the past two decades, lithium-ion (Li-ion) batteries have emerged as a lightweight, high-energy-density rechargeable power source with a good cycle life. A variety of portable electronic devices currently benefit from Li-ion batteries, including laptop computers, mobile phones, digital cameras and camcorders, and Li-ion batteries are viewed by some as a potentially enabling technology for electric vehicles.

A typical Li-ion cell includes two electrodes (an anode and a cathode) with a separator in between that electrically isolates the electrodes from each other without interfering with the flow of lithium ions. The electrodes and separator are immersed in an electrolyte that helps to maintain charge balance during charging and discharging. The electrolyte may include a molten lithium salt, a lithium salt solution, or a lithium salt incorporated in a solid polymer. The anode and cathode of a Li-ion cell each include an active or intercalation material, which is typically carbon-based (e.g., graphite) in the case of the anode and a lithium metal oxide such as LiCoO₂ or LiMn₂O₄ in the case of the cathode.

To charge a Li-ion cell and deliver energy, lithium ions are released from the lithium-containing (lithiated) cathode, transferred to the anode, and intercalated at the anode. During discharge, a reverse process occurs to deliver an electrical current through an external load. Upon subsequent charge and discharge, the lithium ions move between the anode and cathode.

Silicon is a promising alternative high-capacity anode material for lithium-ion cells with a theoretical energy storage capacity that is ten times higher than that of carbon. However, silicon-based anodes have been plagued by poor cycle life and capacity fade with repeated cycling due to the extensive volumetric changes that can occur during lithium ion insertion/de-insertion. Polycrystalline silicon anodes have been known to swell up to 400% during charging, which can lead to fracture of the anode material after only a few cycles.

### BRIEF SUMMARY

According to one embodiment, a method of controlling the crystallinity of a silicon powder may include heating a reactor to a temperature of no more than 650° C., and flowing a feed gas comprising silane and a carrier gas into the reactor at a molar gas flux of from about 5 mol/min/m² to about 25 mol/min/m². The silane decomposes to form a silicon powder having a controlled crystallinity and comprising non-crystalline silicon.

According to another embodiment, the method of controlling the crystallinity of a silicon powder may include flowing a feed gas comprising silane and a carrier gas into a heated reactor at a molar gas flux of from about 5 mol/min/m² to about 25 mol/min/m², and maintaining an internal reactor pressure of about 2 atm or less during the flowing of the feed gas into the heated reactor. The silane decomposes to form a silicon powder having a controlled crystallinity and comprising non-crystalline silicon.

### BRIEF DESCRIPTION OF THE DRAWINGS

FIG. 1 is a schematic of a free space reactor employed for the synthesis of silicon powder;

FIG. 2A shows x-ray powder diffraction data for various exemplary silicon powder samples (examples 5, 14 and 18-27) at room temperature;

FIG. 2B shows an overlay of differential scanning calorimetry (DSC) data obtained from various silicon powder samples;

FIG. 2C shows x-ray powder diffraction data for various exemplary silicon powder samples (examples 18-26) after elevated temperature exposure;

FIG. 3 shows experimental pair distribution functions G(r) (solid line) for the silicon powders of example 14, example 22, example 5, and example 18, with corresponding fits shown as hollow circles, where sparse markers were used for clarity, with 1 hollow circle shown for every 10 data points from the fit; the plots are offset from each other for clarity;

FIG. 4 shows comparisons of the (111) reflection in the powder diffraction patterns of example 5 as a function of temperature, indicating a sudden glass-to-crystalline transition;

FIG. 5 shows comparisons of the (111) reflection in the powder diffraction patterns of example 14 as a function of temperature, indicating a sudden glass-to-crystalline transition;

FIGS. 6A-6B are scanning electron microscope (SEM) images of powders from example 5;

FIGS. 7A-7D are scanning electron microscope (SEM) images of powders from example 24 (7A and 7B) and example 18 (7C and 7D);

FIG. 8 is a plot obtained from Fourier transform infrared (FTIR) analysis;

FIG. 9 shows a ²⁹Si MAS NMR spectral overlay of non-crystalline silicon powders (example 14, top curve, and example 5, second curve from top) and crystalline silicon (two bottom curves);

FIGS. 10A-10I are lithiation/delithiation curves for electrodes formed using silicon powder of examples 4, 5, 14, 18, 19, 20, 21, 22, and -23 in a half-cell configuration against a lithium metal anode with an electrolyte containing EC:EMC 3:7 (by wt.) with 1M LiPF₆; electrochemical cycling details for each example are provided in each figure;

FIGS. 11A-11H are lithiation/delithiation curves for electrodes formed using the silicon powder of examples 5 and 27 in a half-cell configuration using a lithium metal anode with an electrolyte containing EC:DEC 1:1 (by wt.) and 1M LiPF₆+10 wt. % FEC; electrochemical cycling details for each example are provided in each figure;

FIGS. 12A-D show the delithiation capacity of electrodes formed using the silicon powder of examples 5 and 27 as a function of cycle number in a half-cell configuration using a lithium metal anode with an electrolyte containing EC:DEC 1:1 (by wt.) and 1M LiPF₆+10 wt. % FEC; electrochemical cycling details for each example are provided in each figure;

FIG. 13A presents the first cycle Coulombic efficiency (CE) of electrodes formed using the silicon powder of examples 5 and 27 in a half-cell configuration using a lithium metal anode with an electrolyte containing EC:DEC 1:1 (by wt.) and 1M LiPF₆+10 wt. % FEC; electrochemical cycling details for each example are provided in each figure;

FIG. 13B presents the cycle life for electrodes formed using the silicon powder of examples 5 and 27 in a half-cell configuration using a lithium metal anode, with an electrolyte containing EC:DEC 1:1 (by wt.) and 1M LiPF₆+10 wt. % FEC; the cycling conditions are shown in the figure, and the cycle life is defined as the number of cycles until the delithiation capacity has decreased to 80% of the first post-formation cycle (in this case the third cycle); ;

FIGS. 14A-B are first cycle lithiation/delithiation curves for electrodes formed using the silicon powder of examples 18 and 23 in a full-cell configuration including a LiCoO₂ cathode with an electrolyte containing EC:DEC 1:1 (by wt.) with 1M LiPF₆. FIGS. 14C is the full-cell cycle performance of example 23.

### DETAILED DESCRIPTION

A composition comprising a silicon powder that includes both non-crystalline and crystalline silicon, a method of controlling the crystallinity of a silicon powder, and an electrode for an electrochemical cell are described in the present disclosure.

The silicon powder may be processed to form an electrochemically active material for an electrode of a secondary electrochemical cell, such as a Li-ion cell. Due to the controlled amount of non-crystalline silicon in the silicon powder, in conjunction with a small primary particle size and/or a substantially spherical particle morphology, the electrode may prove resistant to fracture associated with swelling of the active material that accompanies charging and discharging of the Li-ion cell. The electrode may also exhibit a high coulombic efficiency and excellent charge storage capacity. The silicon powder may also find use in other industrial applications.

As used in the present disclosure, the term “powder” or “powders” refers to a plurality of primary particles that may take the form of discrete particles, agglomerates/aggregates of primary particles, or partially sintered clumps/flakes formed from the primary particles and/or agglomerates. Aggregates (or agglomerates) of the primary particles may be hundreds of microns in average size (e.g., up to about 300 microns), and partially sintered clumps/flakes may be up to tens of centimeters in size. The powder may be a dry powder or it may be immersed in a liquid to form a suspension of the primary particles and/or agglomerates.

Also, the phrase “having a controlled crystallinity,” when used in reference to silicon powder, means containing a predetermined amount of non-crystalline silicon and/or crystalline silicon.

The term “non-crystalline silicon” refers to silicon that does not possess the long-range order associated with monocrystalline silicon or polycrystalline silicon. The non-crystalline silicon may include also some amount of hydrogen, as discussed further below.

The composition of the present disclosure comprises a silicon powder comprising non-crystalline silicon and crystalline silicon. Non-crystalline silicon may account for at least about 10 wt. %, at least about 25 wt. %, at least about 50 wt. %, at least about 75 wt. %, at least about 90 wt. %, at least about 95 wt. %, or at most about 99 vol. % of the silicon powder, with crystalline or semi-crystalline silicon accounting for any remainder. Advantageously, the silicon powder may include no more than about 30 wt. % crystalline silicon, no more than about 20 wt. % crystalline silicon, no more than about 10 wt. % crystalline silicon, or no more than about 5 wt. % crystalline silicon. The silicon powder may also include at least about 1 wt. % crystalline silicon, or at least about 3 wt. % crystalline silicon.

In addition, the silicon powder may have an average primary particle size ranging from tens of nanometers to tens of microns (e.g., about 20 microns) in size. For example, the average primary particle size may lie between about 0.05 micron (50 nm) and about 4 microns, or between about 0.05 micron (50 nm) and about 0.4 micron. The primary particles of the silicon powder may be spherical in morphology. The silicon powder may comprise a BET surface area of from about 2 m²/g to about 10 m²/g, and a true density value of about 2.3 g/cm³. The silicon powder may also comprise a hydrogen content of about 0.05 wt. % or less. When heated, the silicon powder may comprise a differential scanning calorimetry (DSC) onset temperature of no more than about 700° C., where the DSC onset temperature represents the onset of a transformation to crystalline silicon.

The silicon powder may include a homogeneous distribution of the non-crystalline silicon and the crystalline silicon. For example, one or more primary particles may include both the non-crystalline silicon and the crystalline silicon. Also, or alternatively, one or more agglomerates of primary particles may include both the non-crystalline and the crystalline silicon.

### Free Space Reactor and Powder Synthesis

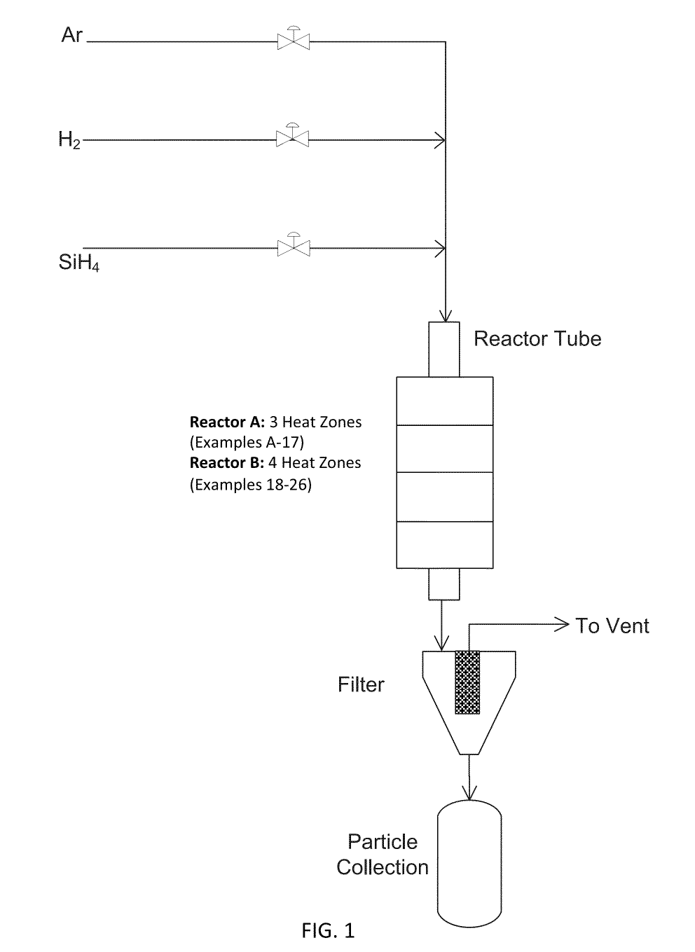

FIG. 1 provides a schematic of a free space reactor that may be employed to synthesize the silicon powders. Silane (SiH₄) and either hydrogen or an inert gas (carrier gas) are mixed and fed into the top of an alumina pipe (Reactor A) or Inconel pipe (Reactor B) which, for the experiments described here, was 78 mm in diameter and 1.5 meters long. Another configuration of the apparatus includes a stainless steel reactor tube of either 71 mm or 142 mm in inner diameter and 1.5 meters in length. While the alumina tube is operable only at or below atmospheric pressure, the stainless steel tube can be operated at, below, or above atmospheric pressure. The flow rates of the silane and the carrier gas may be controlled independently. Prior to introduction of the silane and the carrier gas, the system is evacuated and backfilled with inert gas (e.g., argon or helium) one or more times (e.g. three times).

The internal reactor volume is heated by three resistive heaters (Reactor A) or four resistive heaters (Reactor B). A schematic of Reactor B is shown in FIG. 1. As currently configured, the gases fed to the free space are not preheated. There are three or four heating zones along the reactor tube, and the temperature of each zone can be set to provide a constant, increasing or decreasing temperature along the length of the reactor. For example, the temperature of each heating zone can be selected to allow the gases flowing through the reactor tube to be gradually heated to a desired reaction temperature. The first heat zone (topmost zone shown in FIG. 1) may be heated to a temperature of from about 200° C. to about 400° C.; the second heat zone may be heated to a temperature of from about 300° C. to about 500° C.; the third heat zone (the reaction zone in this example) may be heated to a temperature of about 450° C. to about 650° C.; and the fourth heat zone may be heated to a temperature of from about 100° C. to about 650° C., or from about 100° C. to about 300° C. The reaction zone generally is heated to the highest temperature of the three or four heat zones of the reactor. Thus, when a reactor temperature is specified in the present disclosure without reference to a particular zone, it can be assumed to be the temperature of the reaction zone and also the maximum temperature of the reactor.

Immediately downstream of the heated sections of the reactor, a sintered metal filter traps silicon particles formed in the reactor until a gas back-pulse clears the filter periodically. The powder knocked loose from the filter falls into a stainless steel collection vessel that is removed at the end of a run. The collection vessel is fitted with a valve arrangement to maintain an inert atmosphere over the powder product during transfer to a glove box, where the vessel is opened and the powder product is removed.

A series of 26 experiments to synthesize silicon powder having a controlled crystallinity was carried out in the free space reactor shown schematically in FIG. 1. The process variables included the temperature profile and pressure in the reactor tube, the diluent gas employed and the concentration of silane in the diluent gas, and the total flow rate. The process conditions are summarized in Table 1 and described for each experiment in the examples below. It is believed that the primary factors affecting the crystallinity of the resulting silicon powder are the maximum reactor temperature, the internal reactor pressure, and the choice of diluent gas. Residence time in the reactor tube, which is influenced by the concentration of silane, the pressure and the total flow rate, is also important.

Prior to the 26 experiments, a set of preliminary powder production runs (labeled Examples A-D in Table 1 below) was carried out to determine the transition temperature above which crystalline silicon is produced. The silicon powders obtained from Examples A and B at 580° C. and 600° C., respectively, included a significant fraction of non-crystalline silicon, while the silicon powder of Example C appeared to include a larger fraction of crystalline silicon. Example D yielded a conclusively crystalline Si powder. As a result, subsequent runs (labeled Examples 1-26 in Table 1) were carried out at a temperature below 620° C.

In each of the 26 experiments, the maximum temperature in the reactor tube was maintained at either 456° C., 479° C., 502° C., 524° C., 547° C., 550° C., 580° C., or 592° C., the gas pressure was 0.5 atm, 0.9 atm, 1.0 atm, or 2.0 atm, the mole fraction of silane was 0.2 or 0.8, the flow rate was 1, 2, or 3 liters per minute, and the diluent gas was selected to be argon, hydrogen, or helium. The silane, hydrogen, argon, and helium gases employed for the experiments were obtained from Yara Praxair ASA (Oslo, Norway). The silane had a purity of 4 ppm contaminants; the hydrogen gas had a purity of 5 ppm contaminants; the argon gas had a purity of 5 ppm contaminants; and the helium gas had a purity of 6 ppm contaminants.

The flow rate of the feed gas may be described in terms of molar gas flux, or the rate of molar flow per unit area. The molar gas flux (mol/min/m²) may be calculated by converting the measured volumetric flow rate in liters per minute at standard conditions (25° C. and 1 atm) to a molar flow rate (mol/min), and then dividing by the cross sectional area of the reactor, as set forth in the equation below. The molar volume of an ideal gas is defined as the volume occupied by one mole of that gas at a given temperature and pressure. For any ideal gas at standard temperature this is equal to 24.465 lit/mol.

$$Molar Gas Flux [ \frac{mol}{min \cdot {m}^{2}} . ] = \frac{\frac{Vol Flow Rate [ \frac{lit}{min} ]}{Molar Volume [ \frac{lit}{mol} ]}}{\frac{{π ( \frac{Reactor Dia [ mm ]}{1000} )}^{2}}{4}}$$

As demonstrated, the method of controlling the crystallinity of a silicon powder may include heating a reactor to a temperature of no more than 650° C., and flowing a feed gas comprising silane and a carrier gas into the reactor while maintaining an internal reactor pressure of about 2 atm or less. The silane decomposes to form a silicon powder having a controlled crystallinity. For example, the silicon powder may include non-crystalline silicon and crystalline silicon (>0 to about 90 wt. % crystalline silicon). The silicon powder may also include only non-crystalline silicon (0 wt. % crystalline silicon).

According to another embodiment, the method of controlling the crystallinity of a silicon powder may include heating a reactor to a temperature of no more than 650° C., and flowing a feed gas comprising silane and a carrier gas into the reactor at a molar gas flux of from about 5 mol/min/m² to about 25 mol/min/m². The silane decomposes to form a silicon powder having a controlled crystallinity and comprising non-crystalline silicon.

According to another embodiment, the method of controlling the crystallinity of a silicon powder may include flowing a feed gas comprising silane and a carrier gas into a heated reactor at a molar gas flux of from about 5 mol/min/m² to 25 mol/min/m², and maintaining an internal reactor pressure of about 2 atm or less during the flowing of the feed gas into the heated reactor. The silane decomposes to form a silicon powder having a controlled crystallinity and comprising non-crystalline silicon.

The maximum temperature to which the reactor is heated may be from about 450° C. to about 620° C. Typically, the temperature is greater than about 525° C., and it may also be greater than about 590° C. The carrier gas may be selected from the group consisting of argon, hydrogen and helium. Advantageously, the carrier gas may be argon or hydrogen. The silane may have a concentration in the feed gas of between about 0.2 and about 0.8 mole fraction, and the feed gas may be flowed into the reactor at a flow rate of from about 1 liter per minute to about 3 liters per minute.

The molar gas flux of the feed gas may lie in the range of from about 5 mol/min/m² to about 25 mol/min/m², or from about 8 mol/min/m² to about 21 mol/min/m². For example, the molar gas flux may range from about 5 mol/min/m² to about 7 mol/min/m², from about 8 mol/min/m² to about 10 mol/min/m², from about 11 mol/min/m² to about 13 mol/min/m², from about 14 mol/min/m² to about 16 mol/min/m², from about 17 mol/min/m² to about 21 mol/min/m² or from about 22 mol/min/m² to 25 mol/min/m².

An internal reactor pressure of about 2 atm or less may be maintained during the flowing of the feed gas into the reactor. For example, the internal reactor pressure may be at least about 1 atm. In another example, the internal reactor pressure may be at least about 0.5 atm and less than 1 atm.

Advantageously, embodiments of the method may yield silicon powder including non-crystalline silicon and crystalline silicon (>0 to about 90 wt. % crystalline silicon) or only non-crystalline silicon (0 wt. % crystalline silicon). For example, the silicon powder may include no more than about 20 wt. % crystalline silicon, no more than about 10 wt. % crystalline silicon, or no more than about 5 wt. % crystalline silicon. The silicon powder may also include at least about 1 wt. % crystalline silicon, or at least about 3 wt. % crystalline silicon.

TABLE 1
Compilation of Process Conditions

| | | | Silane | | | | |
|---|---|---|---|---|---|---|---|
| | Max. | | Conc. | Reactor | | Molar Gas | Diluent |
| | Temp. | Pressure | mole | Diameter | Flow rate | Flux | gas |
| Examples | ° C. | atm | fraction | mm | liters/min | Mol/min/m² | species |
| A | 580 | 0.9 | 0.8 | 78 | 1 | 8.6 | H₂ |
| B | 600 | 0.9 | 0.8 | 78 | 1 | 8.6 | H₂ |
| C | 620 | 0.9 | 0.8 | 78 | 1 | 8.6 | H₂ |
| D | 750 | 0.75 | 0.42 | 78 | 1.2 | 10.3 | H₂ |
| 1 | 550 | 0.9 | 0.8 | 78 | 1 | 8.6 | H₂ |
| 2 | 580 | 0.5 | 0.8 | 78 | 1 | 8.6 | H₂ |
| 3 | 580 | 0.5 | 0.8 | 78 | 2 | 17.1 | Argon |
| 4 | 550 | 0.9 | 0.8 | 78 | 2 | 17.1 | Argon |
| 5 | 550 | 0.5 | 0.8 | 78 | 2 | 17.1 | H₂ |
| 6 | 550 | 0.9 | 0.2 | 78 | 2 | 17.1 | H₂ |
| 7 | 550 | 0.9 | 0.2 | 78 | 1 | 8.6 | Argon |
| 8 | 580 | 0.9 | 0.8 | 78 | 2 | 17.1 | H₂ |
| 9 | 580 | 0.9 | 0.2 | 78 | 1 | 8.6 | H₂ |
| 10 | 580 | 0.5 | 0.2 | 78 | 2 | 17.1 | H₂ |
| 11 | 550 | 0.5 | 0.2 | 78 | 1 | 8.6 | H₂ |
| 12 | 580 | 0.9 | 0.2 | 78 | 2 | 17.1 | Argon |
| 13 | 580 | 0.5 | 0.2 | 71 | 1 | 10.3 | Argon |
| 14 | 550 | 0.5 | 0.8 | 71 | 1 | 10.3 | Argon |
| 15 | 550 | 0.5 | 0.2 | 71 | 2 | 20.6 | Argon |
| 16 | 580 | 0.9 | 0.8 | 71 | 1 | 10.3 | Argon |
| 17 | 580 | 0.9 | 0.2 | 78 | 2 | 17.1 | H₂ |
| 18 | 456 | 1.0 | 0.8 | 142 | 3 | 7.7 | Argon |
| 19 | 479 | 1.0 | 0.8 | 142 | 3 | 7.7 | Argon |
| 20 | 502 | 1.0 | 0.8 | 142 | 3 | 7.7 | Argon |
| 21 | 524 | 1.0 | 0.8 | 142 | 3 | 7.7 | Argon |
| 22 | 547 | 1.0 | 0.8 | 142 | 3 | 7.7 | Argon |
| 23 | 592 | 1.0 | 0.8 | 142 | 3 | 7.7 | Argon |
| 24 | 592 | 2.0 | 0.8 | 142 | 3 | 7.7 | Argon |
| 25 | 592 | 1.0 | 0.8 | 142 | 3 | 7.7 | He |
| 26 | 592 | 2.0 | 0.8 | 142 | 3 | 7.7 | He |
| 27 | N/A | N/A | N/A | N/A | N/A | N/A | N/A |
| (Chem | | | | | | | |
| Grade | | | | | | | |
| Si) | | | | | | | |

### EXAMPLE 1

A mixture of silane gas and hydrogen gas was fed into a free space reactor, heated to a temperature of 550° C. The reactor was 78 mm inner diameter, 1.5 meters long and constructed of alumina. The feed gas mixture was 0.8 mole fraction silane, and 0.2 mole fraction hydrogen. The total flow rate of feed gas was 1 liter per minute (measured at standard temperature and pressure (STP) of 1 atmosphere and 25° C).The pressure within the reactor tube was maintained at 0.9 atmospheres. A silicon powder was produced and analyzed.

### EXAMPLE 2

A mixture of silane gas and hydrogen gas was fed into a free space reactor, heated to a temperature of 580° C. The reactor was 78 mm inner diameter, 1.5 meters long and constructed of alumina. The feed gas mixture was 0.8 mole fraction silane, and 0.2 mole fraction hydrogen. The total flow rate of feed gas was 1 liter per minute (measured at standard temperature and pressure (STP) of 1 atmosphere and 25° C).The pressure within the reactor tube was maintained at 0.5 atmospheres. A silicon powder was produced and analyzed. Example 3

A mixture of silane gas and argon gas was fed into a free space reactor, heated to a temperature of 580° C. The reactor was 78 mm inner diameter, 1.5 meters long and constructed of alumina. The feed gas mixture was 0.8 mole fraction silane, and 0.2 mole fraction argon. The total flow rate of feed gas was 2 liters per minute (measured at standard temperature and pressure (STP) of 1 atmosphere and 25° C).The pressure within the reactor tube was maintained at 0.5 atmospheres. A silicon powder was produced and analyzed.

### EXAMPLE 4

A mixture of silane gas and argon gas was fed into a free space reactor, heated to a temperature of 550° C. The reactor was 78 mm inner diameter, 1.5 meters long and constructed of alumina. The feed gas mixture was 0.8 mole fraction silane, and 0.2 mole fraction argon. The total flow rate of feed gas was 2 liters per minute (measured at standard temperature and pressure (STP) of 1 atmosphere and 25° C).The pressure within the reactor tube was maintained at 0.9 atmospheres. A silicon powder was produced and analyzed.

### EXAMPLE 5

A mixture of silane gas and hydrogen gas was fed into a free space reactor, heated to a temperature of 550° C. The reactor was 78 mm inner diameter, 1.5 meters long and constructed of alumina. The feed gas mixture was 0.8 mole fraction silane, and 0.2 mole fraction hydrogen. The total flow rate of feed gas was 2 liters per minute (measured at standard temperature and pressure (STP) of 1 atmosphere and 25° C).The pressure within the reactor tube was maintained at 0.9 atmospheres. A silicon powder was produced and analyzed.

### EXAMPLE 6

A mixture of silane gas and hydrogen gas was fed into a free space reactor, heated to a temperature of 550° C. The reactor was 78 mm inner diameter, 1.5 meters long and constructed of alumina. The feed gas mixture was 0.2 mole fraction silane, and 0.8 mole fraction hydrogen. The total flow rate of feed gas was 2 liters per minute (measured at standard temperature and pressure (STP) of 1 atmosphere and 25° C).The pressure within the reactor tube was maintained at 0.9 atmospheres. A silicon powder was produced and analyzed.

### EXAMPLE 7

A mixture of silane gas and argon gas was fed into a free space reactor, heated to a temperature of 550° C. The reactor was 78 mm inner diameter, 1.5 meters long and constructed of alumina. The feed gas mixture was 0.2 mole fraction silane, and 0.8 mole fraction argon. The total flow rate of feed gas was 1 liter per minute (measured at standard temperature and pressure (STP) of 1 atmosphere and 25° C).The pressure within the reactor tube was maintained at 0.9 atmospheres. A silicon powder was produced and analyzed.

### EXAMPLE 8

A mixture of silane gas and hydrogen gas was fed into a free space reactor, heated to a temperature of 580° C. The reactor was 78 mm inner diameter, 1.5 meters long and constructed of alumina. The feed gas mixture was 0.8 mole fraction silane, and 0.2 mole fraction hydrogen. The total flow rate of feed gas was 2 liters per minute (measured at standard temperature and pressure (STP) of 1 atmosphere and 25° C).The pressure within the reactor tube was maintained at 0.9 atmospheres. A silicon powder was produced and analyzed.

### EXAMPLE 9

A mixture of silane gas and hydrogen gas was fed into a free space reactor, heated to a temperature of 580° C. The reactor was 78 mm inner diameter, 1.5 meters long and constructed of alumina. The feed gas mixture was 0.2 mole fraction silane, and 0.8 mole fraction hydrogen. The total flow rate of feed gas was 1 liter per minute (measured at standard temperature and pressure (STP) of 1 atmosphere and 25° C).The pressure within the reactor tube was maintained at 0.9 atmospheres. A silicon powder was produced and analyzed.

### EXAMPLE 10

A mixture of silane gas and hydrogen gas was fed into a free space reactor, heated to a temperature of 580° C. The reactor was 78 mm inner diameter, 1.5 meters long and constructed of alumina. The feed gas mixture was 0.2 mole fraction silane, and 0.8 mole fraction hydrogen. The total flow rate of feed gas was 2 liters per minute (measured at standard temperature and pressure (STP) of 1 atmosphere and 25° C).The pressure within the reactor tube was maintained at 0.5 atmospheres. A silicon powder was produced and analyzed.

### EXAMPLE 11

A mixture of silane gas and hydrogen gas was fed into a free space reactor, heated to a temperature of 550° C. The reactor was 78 mm inner diameter, 1.5 meters long and constructed of alumina. The feed gas mixture was 0.2 mole fraction silane, and 0.8 mole fraction hydrogen. The total flow rate of feed gas was 1 liter per minute (measured at standard temperature and pressure (STP) of 1 atmosphere and 25° C).The pressure within the reactor tube was maintained at 0.5 atmospheres. A silicon powder was produced and analyzed.

### EXAMPLE 12

A mixture of silane gas and argon gas was fed into a free space reactor, heated to a temperature of 580° C. The The reactor was 78 mm inner diameter, 1.5 meters long and constructed of alumina. The feed gas mixture was 0.2 mole fraction silane, and 0.8 mole fraction argon. The total flow rate of feed gas was 2 liters per minute (measured at standard temperature and pressure (STP) of 1 atmosphere and 25° C).The pressure within the reactor tube was maintained at 0.9 atmospheres. A silicon powder was produced and analyzed.

### EXAMPLE 13

A mixture of silane gas and argon gas was fed into a free space reactor, heated to a temperature of 580° C. The reactor was 71 mm inner diameter, 1.5 meters long and constructed of stainless steel. The feed gas mixture was 0.2 mole fraction silane, and 0.8 mole fraction argon. The total flow rate of feed gas was 1 liter per minute (measured at standard temperature and pressure (STP) of 1 atmosphere and 25° C).The pressure within the reactor tube was maintained at 0.5 atmospheres. A silicon powder was produced and analyzed.

### EXAMPLE 14

A mixture of silane gas and argon gas was fed into a free space reactor, heated to a temperature of 550° C. The reactor was 71 mm inner diameter, 1.5 meters long and constructed of stainless steel. The feed gas mixture was 0.8 mole fraction silane, and 0.2 mole fraction argon. The total flow rate of feed gas was 1 liter per minute (measured at standard temperature and pressure (STP) of 1 atmosphere and 25° C).The pressure within the reactor tube was maintained at 0.5 atmospheres. A silicon powder was produced and analyzed.

### EXAMPLE 15

A mixture of silane gas and argon gas was fed into a free space reactor, heated to a temperature of 550° C. The reactor was 71 mm inner diameter, 1.5 meters long and constructed of stainless steel. The feed gas mixture was 0.2 mole fraction silane, and 0.8 mole fraction argon. The total flow rate of feed gas was 2 liters per minute (measured at standard temperature and pressure (STP) of 1 atmosphere and 25° C).The pressure within the reactor tube was maintained at 0.5 atmospheres. A silicon powder was produced and analyzed.

### EXAMPLE 16

A mixture of silane gas and argon gas was fed into a free space reactor, heated to a temperature of 580° C. The reactor was 71 mm inner diameter, 1.5 meters long and constructed of stainless steel. The feed gas mixture was 0.8 mole fraction silane, and 0.2 mole fraction argon. The total flow rate of feed gas was 1 liter per minute (measured at standard temperature and pressure (STP) of 1 atmosphere and 25° C).The pressure within the reactor tube was maintained at 0.9 atmospheres. A silicon powder was produced and analyzed.

### EXAMPLE 17

A mixture of silane gas and hydrogen gas was fed into a free space reactor, heated to a temperature of 580° C. The reactor was 78 mm inner diameter, 1.5 meters long and constructed of alumina. The feed gas mixture was 0.2 mole fraction silane, and 0.8 mole fraction hydrogen. The total flow rate of feed gas was 2 liters per minute (measured at standard temperature and pressure (STP) of 1 atmosphere and 25° C).The pressure within the reactor tube was maintained at 0.9 atmospheres. A silicon powder was produced and analyzed.

### EXAMPLE 18

A mixture of silane gas and argon gas was fed into a free space reactor, heated to a temperature of 456° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C).The pressure within the reactor tube was maintained at 1.0 atmosphere. A silicon powder was produced and analyzed.

### EXAMPLE 19

A mixture of silane gas and argon gas was fed into a free space reactor, heated to a temperature of 479° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C).The pressure within the reactor tube was maintained at 1.0 atmospheres. A silicon powder was produced and analyzed.

### EXAMPLE 20

A mixture of silane gas and argon gas was fed into a free space reactor, heated to a temperature of 502° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C.). The pressure within the reactor tube was maintained at 1.0 atmospheres. A silicon powder was produced and analyzed.

### EXAMPLE 21

A mixture of silane gas and argon gas was fed into a free space reactor, heated to a temperature of 524° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C).The pressure within the reactor tube was maintained at 1.0 atmospheres. A silicon powder was produced and analyzed.

### EXAMPLE 22

A mixture of silane gas and argon gas was fed into a free space reactor, heated to a temperature of 547° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C).The pressure within the reactor tube was maintained at 1.0 atmospheres. A silicon powder was produced and analyzed.

### EXAMPLE 23

A mixture of silane gas and argon gas was fed into a free space reactor, heated to a temperature of 592° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C).The pressure within the reactor tube was maintained at 1.0 atmospheres. A silicon powder was produced and analyzed.

### EXAMPLE 24

A mixture of silane gas and argon gas was fed into a free space reactor, heated to a temperature of 592° C. The reactor was 142 mm inner diameter, 1.5 meters long and constructed of Inconel. The feed gas mixture was 0.8 mole fraction silane, and 0.2 mole fraction argon. The total flow rate of feed gas was 3 liters per minute (measured at standard temperature and pressure (STP) of 1 atmosphere and 25° C).The pressure within the reactor tube was maintained at 2.0 atmospheres. A silicon powder was produced and analyzed.

### EXAMPLE 25

A mixture of silane gas and helium gas was fed into a free space reactor, heated to a temperature of 592° C. The reactor was 142 mm inner diameter, 1.5 meters long and constructed of Inconel. The feed gas mixture was 0.8 mole fraction silane, and 0.2 mole fraction helium. The total flow rate of feed gas was 3 liters per minute (measured at standard temperature and pressure (STP) of 1 atmosphere and 25° C).The pressure within the reactor tube was maintained at 1.0 atmospheres. A silicon powder was produced and analyzed.

### EXAMPLE 26

A mixture of silane gas and helium gas was fed into a free space reactor, heated to a temperature of 592° C. The reactor was 142 mm inner diameter, 1.5 meters long and constructed of Inconel. The feed gas mixture was 0.8 mole fraction silane, and 0.2 mole fraction helium. The total flow rate of feed gas was 3 liters per minute (measured at standard temperature and pressure (STP) of 1 atmosphere and 25° C).The pressure within the reactor tube was maintained at 2.0 atmospheres. A silicon powder was produced and analyzed.

### EXAMPLE 27

Ground chemical grade polycrystalline silicon powder was obtained from Dow Corning Corporation.

### Silicon Powder Characterization

The silicon powders produced in the experiments were investigated using x-ray diffraction, x-ray fluorescence, pyrolysis gas chromatography mass spectroscopy, electron microscopy, laser diffraction particle size analysis, differential scanning calorimetry, thermal gravimetric analysis, thermal desorption spectroscopy, digestion experiments and/or density measurements, as described below.

### Room Temperature Powder X-Ray Diffraction (XRD)

X-ray diffraction data can provide information about the crystallinity and/or amorphous nature of a specimen. Standard powder diffraction patterns are collected in Bragg-Brentano geometry from 10° to 80° 2θ in 0.02° increments at 2.7°/minute with a Cu anode operating at 40 kV and 44 mA. A 10 mm height limiting slit, ½° divergence slit, open scattering slit, and open receiving slit are used, and intensity data are collected with a high speed detector.

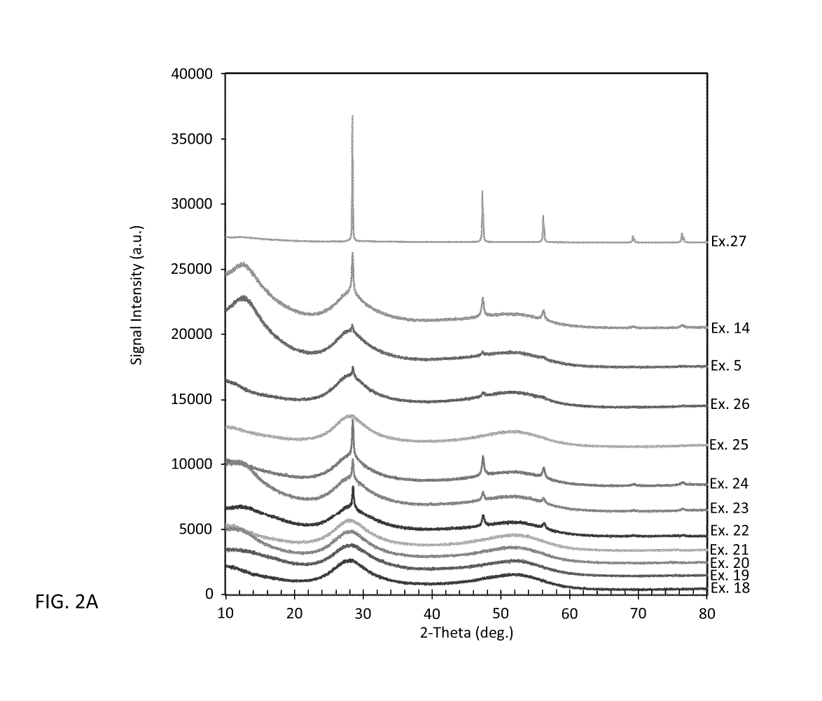

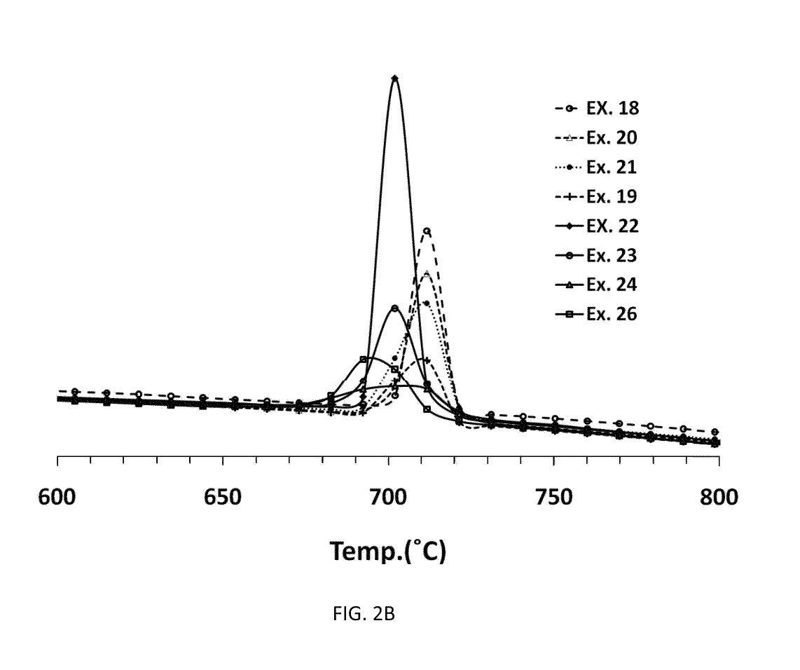

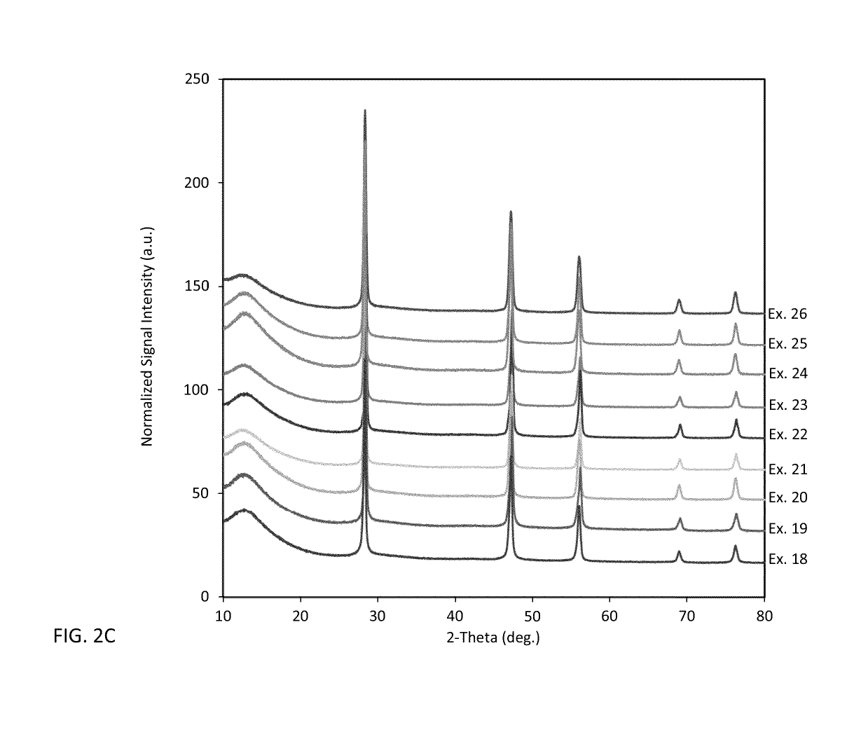

Referring to FIG. 2A, very broad peaks consistent with non-crystalline or amorphous silicon are found in the powder diffraction patterns, and in some cases the diffraction patterns further include narrow, high intensity peaks, consistent with crystalline silicon. For example, the x-ray diffraction pattern obtained from the silicon powder of example 5 may be indicative of either an inhomogeneous mixture of non-crystalline and crystalline Si or a homogenous semi-crystalline Si material. Semi-crystalline Si refers to crystalline Si that may include an appreciable number of defects.

Based on this analysis, it is believed that the silicon powder of example 5 is composed predominantly of non-crystalline Si along with a very small amount of crystalline Si, which may include defects. The silicon powder of example 14 is composed of both non-crystalline and crystalline silicon but with a greater fraction of the crystalline Si component, as evidenced by the more prominent narrow peaks in the x-ray diffraction pattern

Based on the XRD analysis, it is believed that the silicon powder of examples 18, 19, 20, 21 and 25 comprise non-crystalline silicon with little or no (0 wt. %) crystalline Si, while the silicon powder of examples 22, 23, 24 and 26 include non-crystalline Si with some amount (>0 wt. %) of crystalline Si. The structural difference between these two groups of samples may influence their thermal properties, which are described below.

### Pair Distribution Function (PDF) Analysis

Pair distribution function (PDF) analysis can provide information about both the long-range (>100 angstroms) and short range atomic ordering in materials. In particular, PDF analyses can provide “local” (over a 1-50 Å length scale) structural information, such as coordination geometries, bond order, connectivity, and packing of molecular moieties. In principle, traditional XRD data can be converted into PDF data by applying a Fourier transform to the raw data. In practice, to obtain meaningful results, removal of parasitic scattering from the raw data prior to this conversion is preferred, and the use of a diffractometer that includes adequate shielding is also believed to be advantageous.

A method of determining the crystallinity of a silicon powder has been developed. The method entails collecting x-ray diffraction data from a specimen comprising silicon powder, and then performing a Fourier transform of the x-ray diffraction data to obtain pair distribution function (PDF) data. The PDF data are fit with a crystallographic model comprising a first unit cell representing crystalline silicon and a second unit cell representing non-crystalline silicon (alternatively known as amorphous silicon), and then a weight percent crystallinity of the specimen may be determined. Various embodiments of the method are described in detail below.

First, a data acquisition strategy that allows PDF-quality data to be collected reliably from a commercially available laboratory-scale x-ray diffractometer (XRD) is set forth.

A sample holder has been designed and fabricated for XRD analysis of silicon powder specimens. Typical sample holders for XRD are made of silica glass and produce x-ray scattering that generates a broad amorphous background signal that could interfere with the present analysis. Accordingly, the sample holder includes an aluminum frame that has a rectangular opening and a polyimide film (e.g, Kapton) attached to the bottom of the opening; the polyimide film thus forms a reservoir for the silicon powder specimen. A second layer of the polyimide film may be attached to the top of the opening to enclose the reservoir and facilitate analysis of air sensitive samples. The polyimide film is advantageous due to its low x-ray absorption cross-section and low thickness.

To carry out a meaningful PDF analysis, it is advantageous to collect XRD data having a high signal-to-noise ratio over a large integrated range. XRD data are typically collected for 24-72 hours using a commercially available lab-scale diffractometer to achieve this high signal-to-noise ratio. Furthermore, the signal-to-noise ratio may be improved by using particular 20 scanning routines. For example, the 20 angular range may be scanned from 5.0-120.0° in steps of 0.05° with an acquisition time of 15 s per point. This approach yields a total scan time of about 9.6 hours, with 2-6 total scans averaged to produce the final data set (corresponding to 19-58 hours of total data collection time). Incident and receiving slits of ⅔° and a receiving slit of 0.3 mm yield a balance between signal intensity and background scattering. Finally, background measurements may be collected without the sample holder present (i.e., with nothing between the source and the detector), and then with an empty sample holder (i.e., with only a polyimide film (e.g., Kapton tape) between the source and the detector).

A final step to generating high quality PDF data is determination of an effective x-ray absorption coefficient μt for a sample of interest. Using a silicon standard, the XRD signal intensity may be monitored at a θ/2θ position corresponding to strong Bragg peak. An average signal intensity I₀ is obtained by monitoring the signal for several seconds. The sample of interest is then inserted in front of the detector and the intensity I is again recorded for several seconds and used to determine the absorption coefficient/ft according to the following relation:

μt=−ln(I/I₀)

The final data set, the background measurements, and the effective absorption cross section may then be used as inputs for the commercially available data analysis software, PDFgetX2 (J. Appl. Cryst. 37, 678 (2004)), in order to prepare the final PDF results.

The software PDFgetX2 is available from Michigan State University and can be operated within the IDL runtime environment. The final XRD data can be input to the PDFgetX2 software in traditional ascii format (e.g., a comma delimited list of 2θ and corresponding intensity values). Similarly, the background data files are input into the software in the appropriate designated fields, along with appropriate experimental details, including the x-ray conditions (e.g., wavelength and polarization). Once the data files have been loaded and the x-ray conditions specified, the sample information may be supplied to the software. This may include the effective absorption cross section μt, elemental composition, and stoichiometry of the sample.

Various corrections may then be applied to the data. Typically, a flat plate correction is applied to the sample, the sample background and the container background. Similarly, an effective absorption correction may be applied to the sample background and container. Since a negative instrument response is non-physical, any negative values may be reset.

Additional corrections may be made to take into account complicated scattering events that may be present in the final data sets that are not accounted for by background data files. For example, this may include scattering due to the environment that may impart amplitude modifications to the XRD data. As a starting point, corrections for “Sample Self Absorption,” “Compton Scattering,” “Breit Dirac Factor Exponent,” “Laue Diffuse Scattering,” “Weighting Function,” and “Damp F(Q)” may be applied. Once these initial corrections are specified, the data are analyzed and an S(Q) result, where S(Q) represents the normalized scattering intensity or structure function, is obtained. If the S(Q) value does not oscillate around 1, this suggests that the corrections are not being correctly applied at all values of θ/2θ. To improve the S(Q), adjustments to the Breit-Dirac Factor exponent, the sample μt, and polarization factor of the incident x-rays can be made.

Following generation of a suitable S(Q), a Fourier transform is applied to the S(Q) data to produce a G(r) function (i.e. the PDF data). Evidence for poor S(Q) reduction can be discerned as oscillations in the G(r) below 1 Å, as atomic distances of less than 1 Å are non-physical. Iterative improvement of the S(Q) function can be used to reduce the presence of these oscillations.

After meaningful PDF data are acquired, models can be numerically refined against them to extract quantitative information. In reciprocal space, this type of refinement is known as Rietveld refinement and it has been used extensively to provide information on crystalline materials. Here, the refinement is completed in direct space using open source software called PDFgui (J. Phys.: Condens. Matter. 19, 335219 (2007)).

The PDF data obtained as described above are employed and crystallographic models are entered into the program for use in the refinement. Typically, these models are small unit cells that correspond to well crystallized materials. In this case, the standard unit cell for Si was used, along with a much larger cell to represent non-crystalline or amorphous Si (as set forth in Science, 335, 950 (2012), which is hereby incorporated by reference).

The parameters to be refined are specified explicitly. For all samples, a maximum of five parameters was refined: one for each phase accounting for correlated motion, one for each phase allowing the cell parameter to change, and a final parameter (normalized to 100%) accounting for the relative ratio of these two materials. After the data and the unit cells have been entered and the parameters specified, the refinement may be carried out, and typically completes in 2-10 minutes.

High energy XRD data used to compute PDFs for the silicon powder of several examples were collected in Bragg-Brentano geometry from 5° to 120° 2θ in 0.05° increments at 15 seconds per step with a Mo anode operating at 50 kV and 50 mA. A 10 mm height limiting slit, ⅔° divergence slit, ⅔° scattering slit, 0.3 mm receiving slit were used, and intensity data were collected with a scintillation counter. Multiple (≧2) scans were collected under these conditions and averaged. The data were processed as described above, and relative concentrations for each unit cell structure were extracted from the refined scale factors. Other variables that were refined include the linear atomic correlation factor and/or the silicon cell parameter.

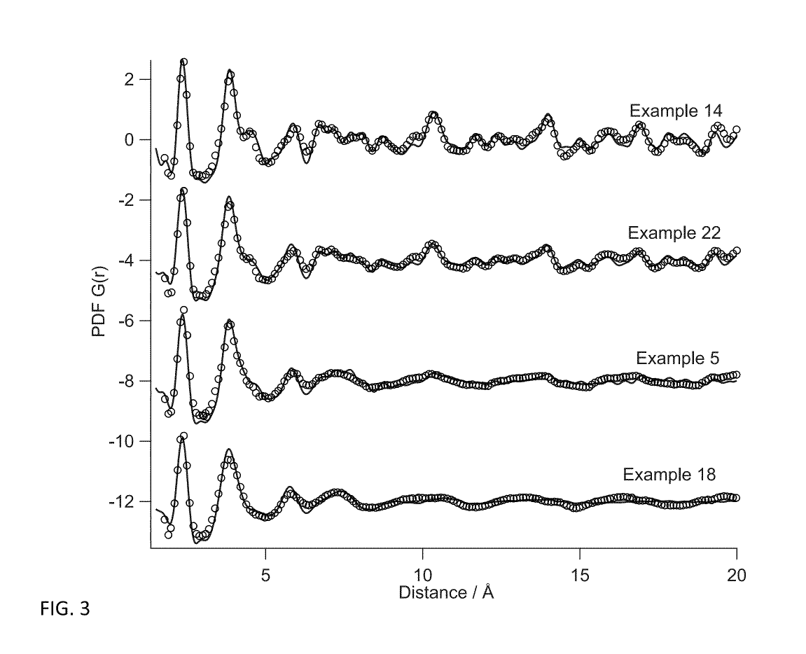

Referring to FIG. 3, positive peaks in PDF plots occur at real space distances corresponding to atomic pairs. In a crystalline material, peaks are theoretically observed to distances equal to the macroscopic crystallite dimensions. In the present examples, however, these oscillations are dampened, suggesting substantially limited structural coherence. The experimental PDF for the silicon powder of example 22 is very similar to that presented in (Science, 335, 950 (2012)), wherein the material is defined as “amorphous silicon.” The oscillations up to 20 angstroms in examples 14 and 22 may be evidence for an admixture of amorphous and semi-crystalline, or crystalline Si. These results suggest that the silicon powders of the examples are composed predominately or entirely of silicon, rather than, for example, SiO, SiO₂, SiC, and others. Furthermore, through a fitting procedure of the PDFs as described above using models representing the crystalline and non-crystalline or amorphous components, the silicon powder of examples 5, 14, 18, and 22 were found to include about 1%, about 10%, about 0%, and about 5% crystalline silicon, respectively.

### High Temperature XRD

Referring to FIG. 2C, high temperature powder diffraction patterns were collected on the silicon powders of example 5 and example 14, and the conversion of non-crystalline Si to crystalline Si was observed with increasing temperature. The data were collected in Bragg-Brentano geometry from 10° to 80°2θ in 0.02° increments at 5°/minute with a Cu anode operating at 40 kV and 44 mA. A 10 mm height limiting slit, ½° divergence slit, open scattering slit, open receiving slit were used, and intensity data were collected with a high speed detector. Temperatures were reached with a heating rate of nominally 10° C., followed by a brief (˜5 min) equilibration time.

For the silicon powders of both examples 5 and 14, only insignificant changes were observed in the powder patterns up to 550° C., indicating thermal stability of the starting microstructure. At room temperature, XRD data from both examples contained broad features consistent with an amorphous Si component and also narrower peaks assignable to a crystalline Si component, and a single weak reflection that may be assignable to SiO₂ in the cristobalite polymorph. (The cristobalite may have been from the underlying SiO₂ example holder or it may have been a part of the example.)

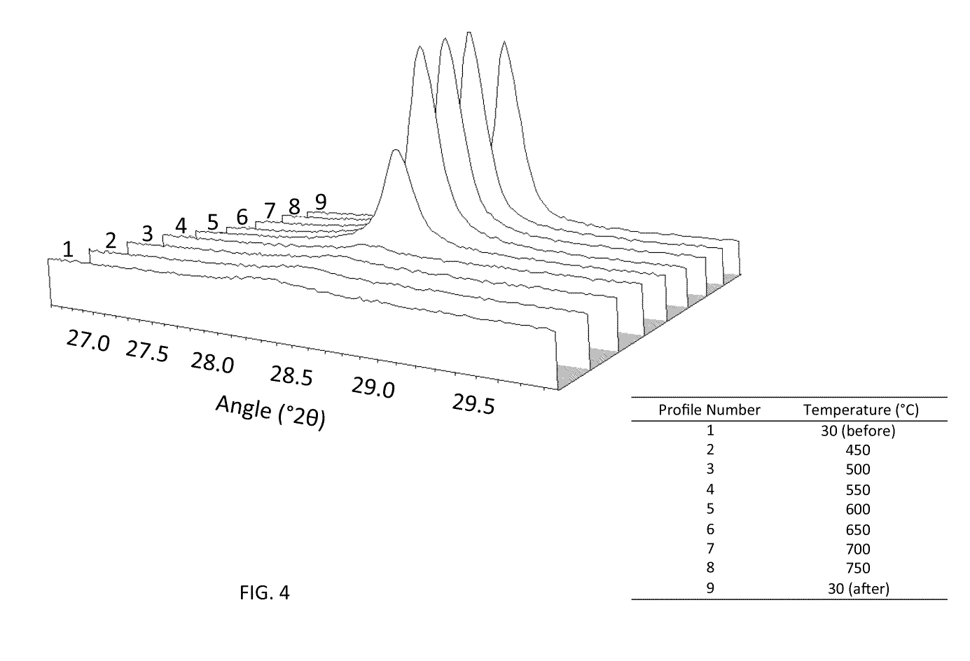

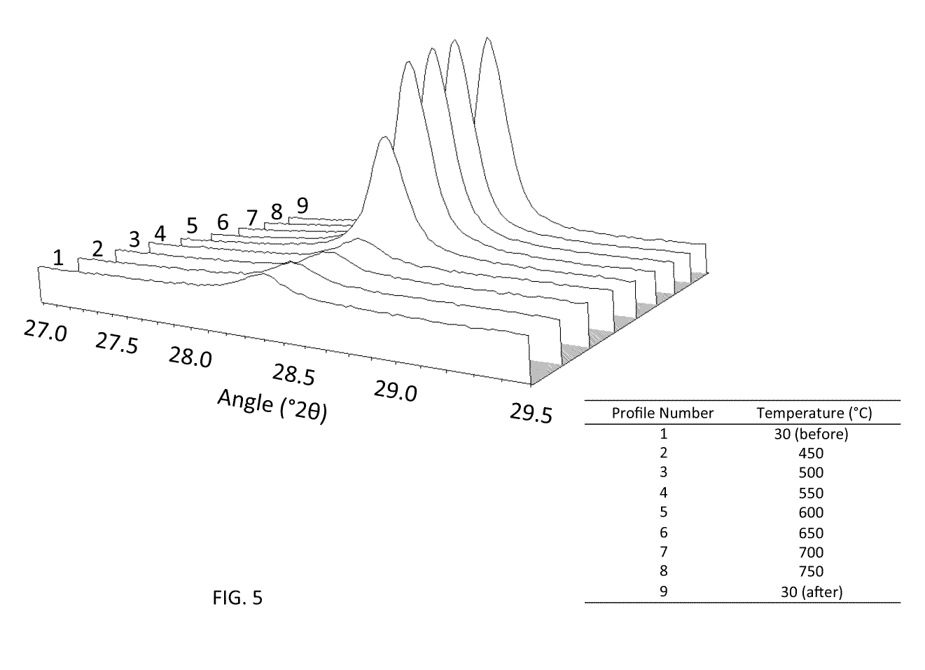

Referring to FIGS. 4 and 5, which show the (111) peak as a function of temperature for the silicon powder of examples 5 and 14, respectively, a strong (111) peak was observed in the data at 600° C., indicating increased amounts of crystalline Si. At 650° C., the peaks had grown stronger, and beyond that temperature, no additional changes were observed. This behavior is consistent with a sudden enthalpic glass-to-crystalline transition.

### X-Ray Fluorescence (XRF)

XRF analysis using a Rigaku Primus IV gave identical compositions for the silicon powder of examples 5 and 14 of about 98% silicon, 1.5% oxygen, 0.5% carbon, and traces of the main components of stainless steel (Fe, Cr, Ni) as expected from the apparatus used. This procedure has a detection limit below 1 part per thousand by mass for most elements.

Pyrolysis Gas Chromatography Mass Spectrometry (py-GC-MS)

Pyrolysis gas chromatography mass spectrometry (py-GC-MS) is a technique where the nature and/or amount of gas vapor evolved from a specimen is measured as a function of temperature or time and specified atmosphere. The technique may be employed to screen for evolved organic or silicon-containing volatile species that may be present as particle contamination.

Py-GC-MS instrumentation includes a furnace, a gas analyzer and/or a gas chromatograph (GC) coupled with a mass spectrometer (MS) detector. The furnace is connected to the inlet of the GC-MS, and volatiles and degradation products from the specimen are injected onto the GC column for separation and subsequently identified by the mass spectrometer.

Thermal extraction was conducted at 300° C. for the silicon powder of both examples 5 and 14, and no evolved volatile or semi-volatile compounds were detected.

### Scanning Electron Microscopy (SEM)

To elucidate the particle morphology, scanning electron microscopy of the silicon powder specimens was conducted using a JEOL 6335 Scanning Electron Microscope (SEM) with a field emission electron source operated at 20 KV and a working distance of between 8 and 20 mm. No conductive coating was needed nor applied for samples #5 and #14. While Pd/Au coating was given in 10 nm thickness for samples #18 and #22.

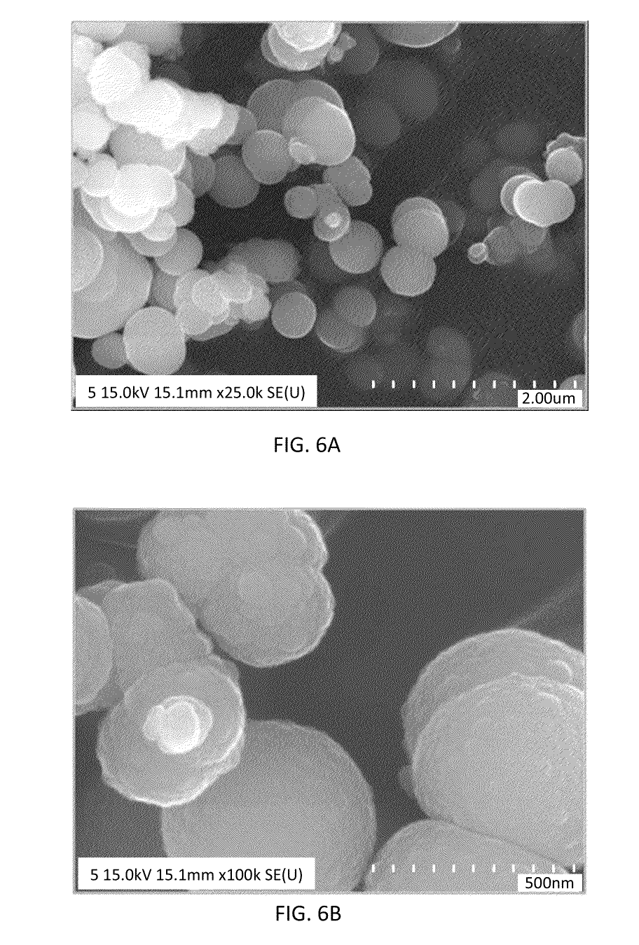

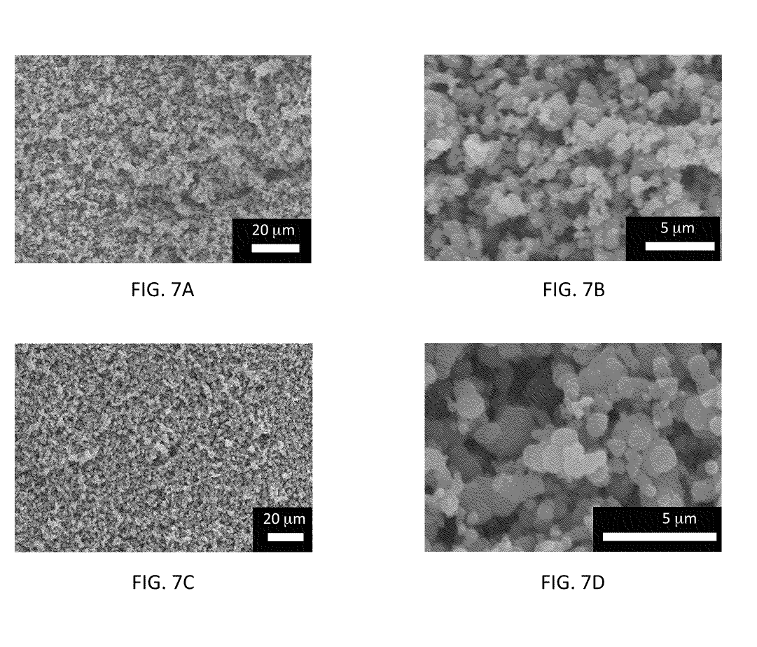

This imaging technique revealed that the silicon powder of both examples 5 and 14 includes spherical particles with a primary size of from about 50 to about 400 nm, with most particles around 100 to about 200 nm in size. The SEM images of FIGS. 6A-6B, taken from example 5, and the SEM images of FIGS. 7A-7B, taken from example 24, and the SEM images of FIGS. 7C-7D, taken from example 18, show only spherical particles.

### Fourier Transform Infrared (FTIR) Analysis

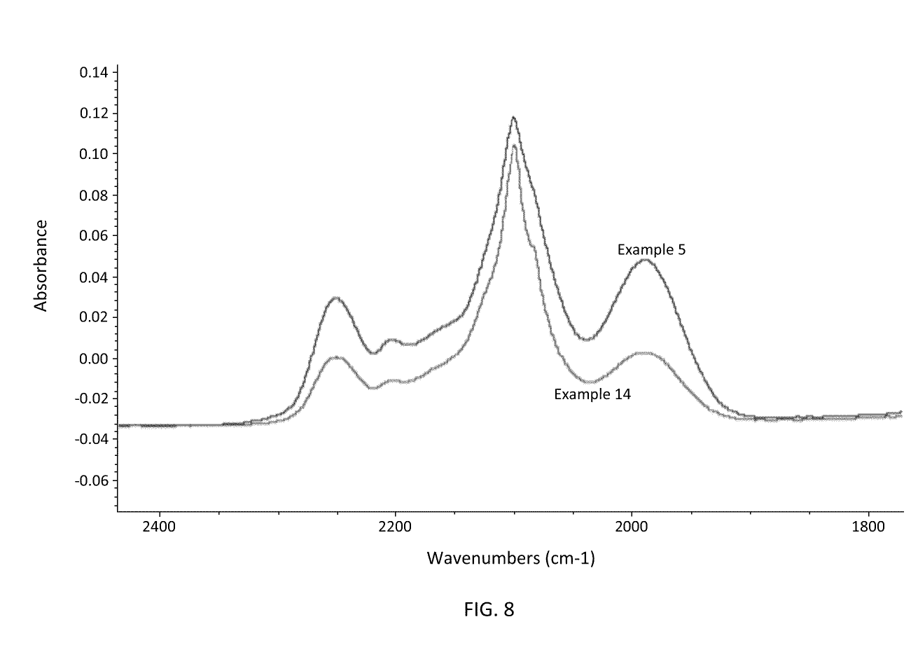

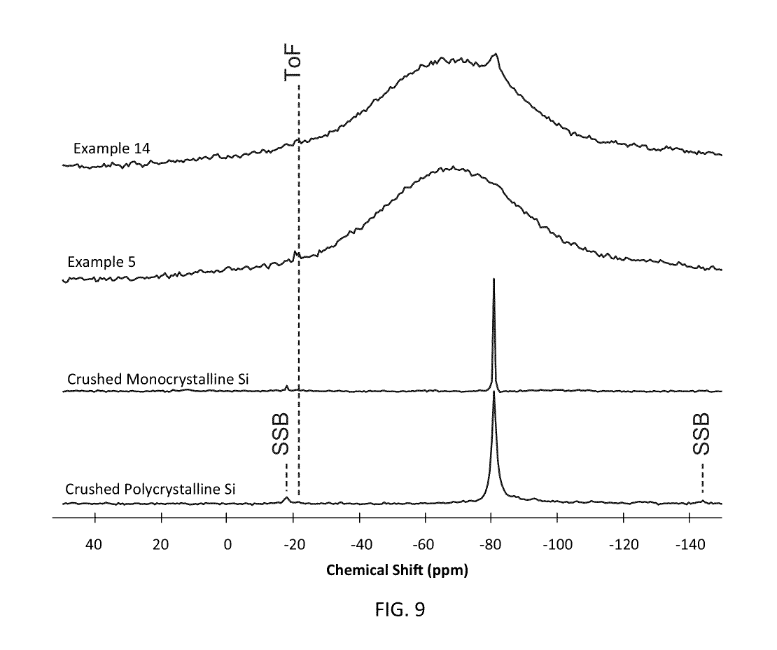

Referring to FIG. 8, which shows data for the silicon powder of examples 5 (top) and 14 (bottom), infrared spectra were measured and bands consistent with SiH species were found. Specifically, the entire region centered near 2100 cm⁻¹ is likely due to SiH species, of which there are numerous types.

### Thermal Desorption Spectroscopy (TDS)

Thermal desorption spectroscopy (TDS) was performed on four silicon powder specimens to evaluate hydrogen content. In a TDS experiment, a known amount of example is heated at a constant heating rate while connected to a vacuum-pumping system equipped with a sensor for monitoring the gas flow. One experiment was performed for each example using a heating rate of 5° C./min to a temperature of 800° C. The integrated amount of hydrogen (assuming all of the desorbed gases are hydrogen) is presented in Table 2 for each sample tested (examples 5, 13, 14 and 16).

TABLE 2
Hydrogen Content from TDS

| Example | wt. % |
|---|---|
| 5 | 0.045 |
| 14 | 0.023 |
| 16 | 0.025 |
| 13 | 0.032 |

### Digestion Experiments

Digestion experiments were employed to determine the amount of SiH in the silicon powders. The silicon powders were reacted with KOH in ethanol to convert the SiH to H₂ gas, and the H₂ gas was measured by GC quantitatively to determine the SiH content of the sample. All of the samples examined (the silicon powder of examples 1-17) contained between 400 and 900 ppm of SiH. In particular, the silicon powder of example 5 contained on average 724 ppm of SiH, and the silicon powder of example 14 contained 889 ppm of SiH. The results are based on a 1 hour digestion since it was found that most of the samples showed only a small increase in H₂ (1 0% or less) with extended digestion times, including setting overnight at room temperature.

### BET Surface Area Measurements

BET analysis is based on the physical adsorption of gas molecules on a solid surface, e.g., a particle surface. The silicon powder samples were prepared by applying heat while under vacuum (a degas process) to remove any surface contaminants. After degassing, the N₂ adsorption experiments were conducted using an automated micropore gas analyzer Autisorb-iQ (Quantachrome Instruments) in the relative pressure range of 0.05<P/P°<0.3. The cryogenic temperatures were controlled using liquid nitrogen at 77 K. About 0.2 g of activated samples were used for BET analysis. An ultra high purity compressed nitrogen gas (UHP 5.0) was used for analysis. The surface area was determined by applying the BET reduction theory. Results are compiled in Table 3 below.

TABLE 3
Results of BET Measurements

| Sample ID | Outgas Condition | BET (m²/g) | Sample weight (g) |
|---|---|---|---|
| Example 18 | 3 hours at 250° C. | 3.22 | 0.210 |
| Example 19 | 3 hours at 250° C. | 3.82 | 0.197 |
| Example 20 | 3 hours at 250° C. | 2.70 | 0.200 |
| Example 21 | 3 hours at 250° C. | 3.04 | 0.200 |
| Example 22 | 3 hours at 250° C. | 2.31 | 0.204 |
| Example 23 | 3 hours at 250° C. | 2.80 | 0.202 |
| Example 24 | 3 hours at 250° C. | 3.38 | 0.202 |
| Example 25 | 3 hours at 250° C. | 4.31 | 0.201 |
| Example 26 | 3 hours at 250° C. | 2.97 | 0.202 |
| Example 5 | 3 hours at 250° C. | 9.55 | 0.158 |
| Example 14 | 3 hours at 250° C. | 9.04 | 0.206 |

### Laser Diffraction Analysis

Particle size was determined using laser diffraction analysis. A Nanotrac NPA 150 particle size analyzer (Micotrac Inc.) was employed for a series of laser diffraction experiments on the silicon powders. In this particle size measurement technique, Si particles suspended in a fluid (e.g., isopropanol (IPA)) are subject to random collisions with the thermally excited molecules of the IPA, resulting in Brownian motion. In the Nanotrac, light from a laser diode is coupled to the sample through an optical beam splitter in the Nanotrac probe assembly. The interface between the sample and the probe is a sapphire window at the probe tip. When the laser reflects back at the sapphire window, the signal has the same frequency as the original laser acts as a reference signal for detection. If the laser passes through the sapphire window, it is scattered by suspended Si particles in IPA moving under Brownian motion. The laser light is scattered in all directions, including 180 degrees backwards. This scattered, frequency shifted light is transmitted through the sapphire window to the optical splitter in the probe to the photodetector. These signals of various frequencies combine with the reflected signal of un-shifted frequency (Controlled Reference) to generate a wide spectrum of heterodyne difference frequencies. The power spectrum of the interference signal is calculated with dedicated high speed FFT (Fast Fourier Transform) digital signal processor hardware. Then, a particle size distribution is inferred from the collected diffracted light data using an inversion algorithm.

Prior to the analysis, a mixture of about 15 mL of IPA and 0.001 to 0.002 grams of sample was prepared in a 20 mL glass vial. The mixture was then treated by sonication for 20 minutes to prevent or reduce agglomeration, and the sonicated mixture was then introduced to a particle size analyzer. The “d₅₀” particle size values (where about 50% of the distribution has a particle size below the value) are presented for the silicon powders of each example in Table 4 below, where the units for particle size are microns. Since nano-size and micron size particles are presented from SEM images, d₁₀ and d₉₀ particle size values are also presented in Table 4. As shown in the SEM images of FIG. 6, sample 5 shows ˜500 nm size particle in d₅₀; however, larger particles (3.5 μm in d₉₀) are also detected from the light scattering analysis. The PSD values from Table 4 show a wide range, from 0.17 μm to 3.16 μm for d₁₀ and from 0.45 μm to 3.59 μm for d₅₀, respectively. Therefore, SEM and light scattering studies confirm that the silicon powders may include a bimodal or multimodal particle size distribution.

TABLE 4
Characterization Results

| Sample ID | Loading index | d₁₀ (μm) | d₅₀ (μm) | d₉₀ (μm) |
|---|---|---|---|---|
| Example 18 | 0.419 | 0.37 | 3.12 | 3.79 |
| Example 19 | 0.161 | 0.67 | 1.01 | 3.57 |
| Example 20 | 0.348 | 0.60 | 3.02 | 3.82 |
| Example 21 | 0.256 | 0.42 | 3.06 | 3.82 |
| Example 22 | 0.187 | 0.32 | 0.61 | 3.55 |
| Example 23 | 0.355 | 0.17 | 0.90 | 1.45 |
| Example 24 | 0.399 | 3.16 | 3.59 | 3.98 |
| Example 25 | 0.277 | 0.52 | 0.80 | 1.30 |
| Example 26 | 0.262 | 0.17 | 1.02 | 1.35 |
| Example 5 | 0.265 | 0.35 | 0.48 | 3.49 |
| Example 14 | 0.190 | 0.38 | 0.57 | 3.78 |

### Density Measurements

True density results were obtained with a gas pycnometer and represent an average density of individual particles, as opposed to the bulk density of the powder. A true density value of 2.324 g/cm³ was obtained for the silicon powders of example 14 and a value of 2.309 g/cm³ was determined for the silicon powders of example 5; the measured density of polycrystalline silicon powder is 2.319 g/cm³.

### Nuclear Magnetic Resonance (NMR) Spectroscopy Experiments

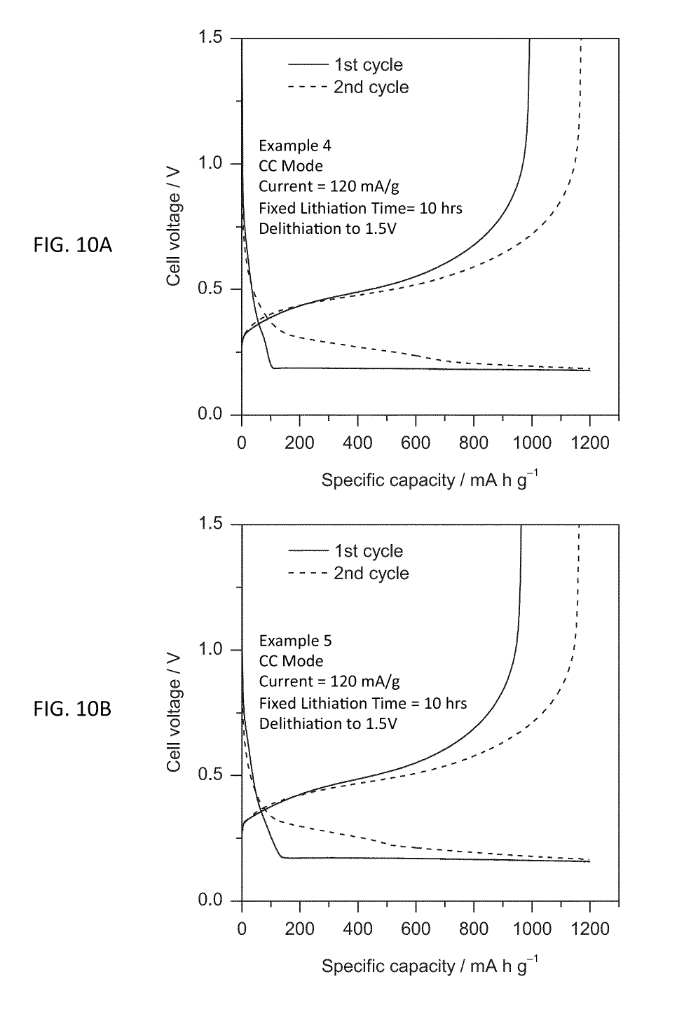

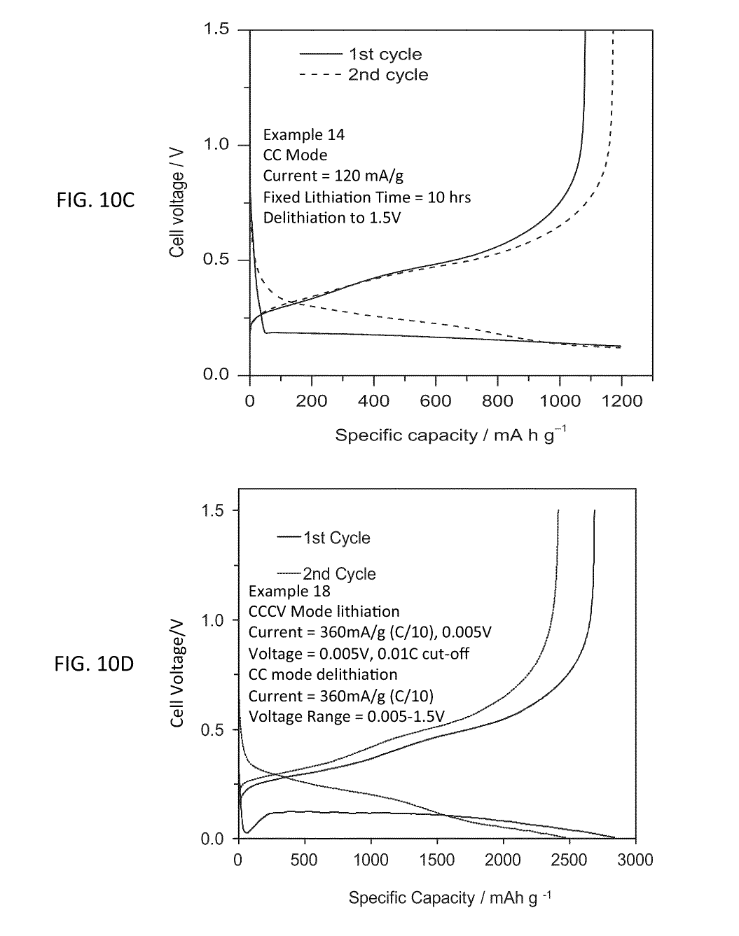

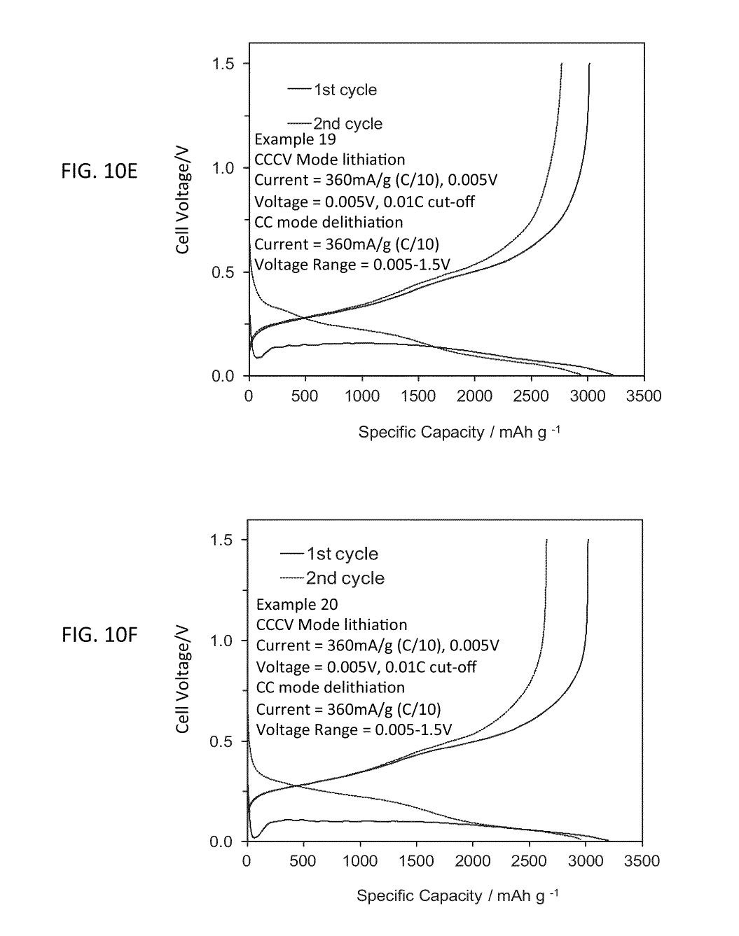

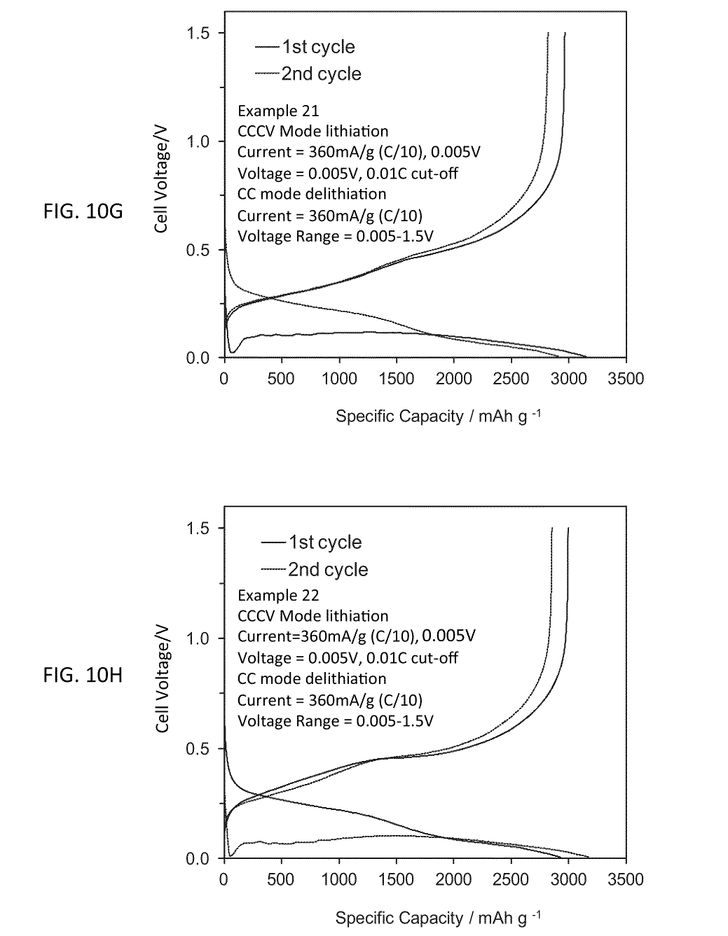

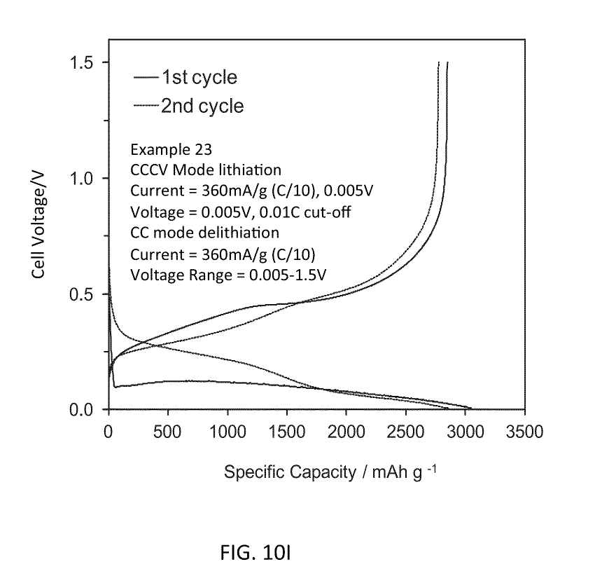

NMR spectroscopy can be used to evaluate the physical and chemical properties of atoms or molecules. For each experiment, approximately 200 mg of silicon powder sample was packed into a 7 mm OD ZrO rotor and spun at 5000 Hz for the duration of the NMR experiment. ²⁹Si MAS NMR spectra were acquired on a Varian Inova NMR spectrometer at 79.4 MHz. Traditional single pulse direct excitation was performed using the xpolvtl rhol pulse sequence. A relaxation period of 90 s was applied between each pulse train. FIG. 10 shows a ²⁹Si MAS NMR spectral overlay obtained from amorphous silicon and crystalline silicon powders.

### Thermogravimetric Analysis and Differential Scanning Calorimetry

Samples were analyzed by thermogravimetric (TG) analysis and differential scanning calorimetry(DSC) using a Mettler Toledo TGA DSC 1. A 14-32 mg sample is placed in 70 μL alumina pan with vented lid to carry out the analysis. The alumina pan is held at 35° C. for 10 minutes and then ramped at 10° C./minute to 1000° C. in air at 60 mL/min. A simultaneous signal for TGA and DSC is collected. All data are blank crucible subtracted.

As summarized in Table 5, all samples shows transition peaks around 700° C. and the resulting phases after analysis are crystalline phases, as depicted in FIG. 2B. Also as shown in FIG. 2B, non-crystalline silicon samples have very similar transition peaks around 713±3° C. (see Table 5), while the crystalline Si-containing samples show different transition peak positions centered at about 701±5° C. Since XRD patterns after the TG-DSC analysis (and concomitant heating) showed only a crystalline Si phase, it is believed that there are two types of transition routes: one from non-crystalline Si to crystalline Si around 713° C. from silicon powders that are composed substantially entirely of non-crystalline samples, and another transition route for silicon powders that include crystalline silicon in addition to non-crystalline silicon (e.g., examples 22, 23, 24, and 26). In addition, the enthalpy values of transition are relatively low in the case of crystalline Si-containing samples. The onset temperatures of this transition show that silicon powders that are composed substantially entirely of non-crystalline silicon, e.g., examples 18-21, may exhibit broader peaks and higher onset temperatures than silicon powder samples that include some crystalline Si (e.g., examples 22-24, 26). In addition, non-crystalline samples generally show higher enthalpy values of transition, which suggests that there may be two different transitions (non-crystalline to crystalline and crystalline to crystalline) that occur in silicon powder samples depending on the crystallinity of the sample. It is believed that a partly crystalline silicon powder specimen (e.g., 5% crystalline Si for example 22 based on aforementioned PDF analysis) may require a lower energy for the transitions since there is an existing crystalline phase.

TABLE 5
Results from TGA and DSC Analysis

| | TGA Wt | | | | |
|---|---|---|---|---|---|
| | Gain | Absolute | DSC | | |
| | from 35 | Mass Gain | Onset | | |
| | to 1000° C. | to 1000° C. | Temp | DSC Peak | Enthalpy |
| Sample | (wt. %) | (mg) | (° C.) | Temp (° C.) | (J/g) |
| Ex. 18 | 2.28 | 0.57 | 708 | 716 | 268 |
| Ex. 19 | 3.05 | 0.80 | 705 | 712 | 276 |
| Ex. 20 | 2.63 | 0.61 | 705 | 711 | 278 |
| Ex. 21 | 2.69 | 0.68 | 702 | 710 | 289 |
| Ex. 22 | 2.94 | 0.95 | 700 | 706 | 269 |
| Ex. 23 | 2.84 | 0.73 | 690 | 701 | 239 |
| Ex. 24 | 2.96 | 0.50 | 670 | 708 | 234 |
| Ex. 25 | 3.44 | 0.66 | 684 | 695 | 275 |
| Ex. 26 | 2.66 | 0.49 | 680 | 696 | 280 |

### Fabrication and Testing of Electrode for Li-Ion Cell

The silicon powders prepared as described above may be employed to form an electrode (e.g., an anode in a full-cell configuration) for an electrochemical cell, such as a lithium ion battery cell. The electrochemical cell may include a first electrode, a second electrode, and an electrolyte in contact with the first and second electrodes, where the first electrode, which may be an anode, includes an electrochemically active (or electroactive) material made from the silicon powders. The electroactive material may include both non-crystalline silicon and crystalline silicon in any amount set forth above. Both the crystalline and non-crystalline silicon may be present prior to cycling the first electrode. It is also contemplated that the electroactive material may include non-crystalline silicon without any (0 wt. %) crystalline silicon prior to cycling the first electrode. In some embodiments, the first electrode may comprise a film comprising the electroactive material. The first electrode may further comprise a binder, where a weight ratio of the electrochemically active material to the binder is about 95:5 or less.

Advantageously, the first electrode is substantially resistant to swelling during cycling of the battery cell. The first electrode may exhibit a Coulombic efficiency of at least about 80% after a first cycle of the electrochemical cell. Preferably, the Coulombic efficiency is at least about 90% after the first cycle. The first electrode may exhibit a charge storage capacity of at least about 1000 mAh/g, and in some embodiments, the charge storage capacity may be at least about 3000 mAh/g.

The silicon powders of examples 4, 5, 14, 18, 19, 20, 21, 22, 23, and 27 were processed to form the electroactive material of exemplary silicon electrodes that underwent lithiation/delithiation cycling tests as described below.

### Electrode Preparation

To prepare the electrodes of FIGS. 10A, 10B, and 10C, the active material, poly(acrylic acid) (Mw=25,000; Wako Purechemical), carboxymethylcellulose sodium (degree of polymerization=500; Tokyo Kasei), and acetylene black (Denka) were put in a glass vial in a weight ratio of 70:10:5:15 (1000 mg in total). A proper amount of ultrapure water (>2000 μL) was then added to the glass vial. The aqueous slurry was mixed using a Thinky mixer and then applied onto copper foil using a bar coater. The coated copper foil was placed in an oven at 85° C. under vacuum. For examples 4, 5, and 14, the coated copper foil was calendar ed with a two-roller press following. The working electrode (14 mm diameter) was then cut away from the coated pressed copper foil.

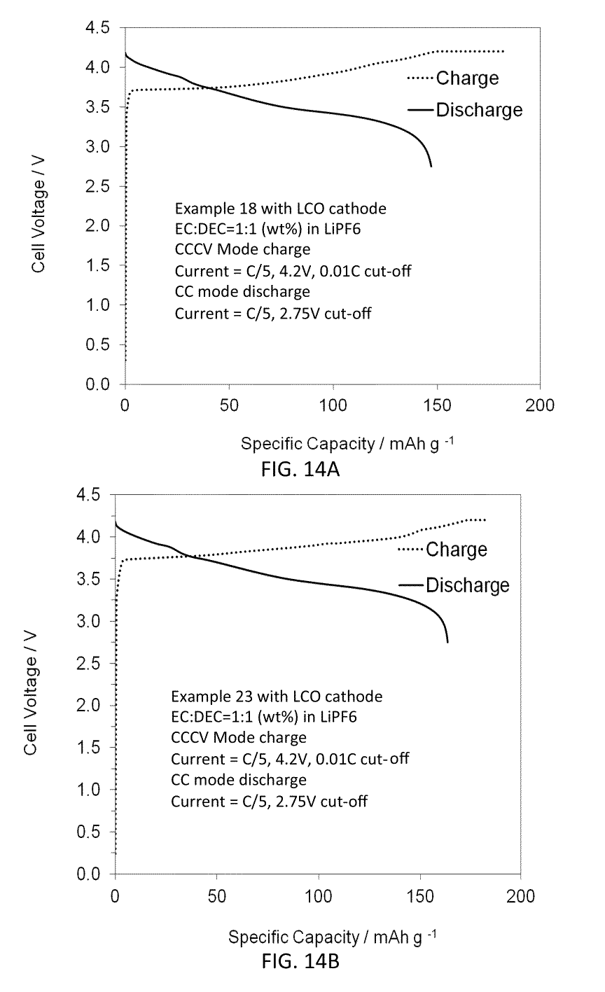

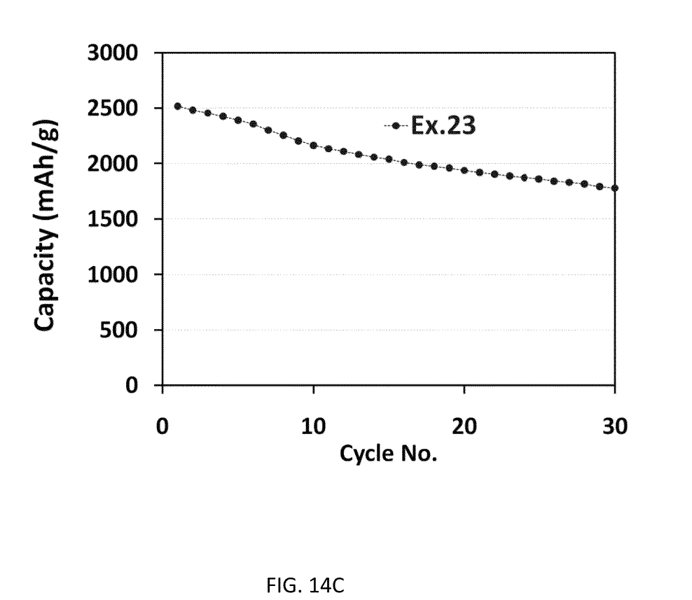

To prepare the electrodes of FIGS. 10D-1, and 14A-C, the active material, poly(acrylic acid) (Mw=450,000; Sigma Aldrich), and acetylene black (Denka) were put in a glass vial in a weight ratio of 70:15:15 (1000 mg in total). A proper amount of deionized distilled water (>2000 μL) was then added to the HDPE vial. The aqueous slurry was mixed using a Thinky mixer and then applied onto copper foil using a bar coater. The coated copper foil was placed in an oven at 120° C. under vacuum. For FIGS. 10D-10I, and 14, the coated copper foil was calendared with a two-roller press following water removal. The working electrode (15 mm diameter) was then cut away from the coated pressed copper foil.

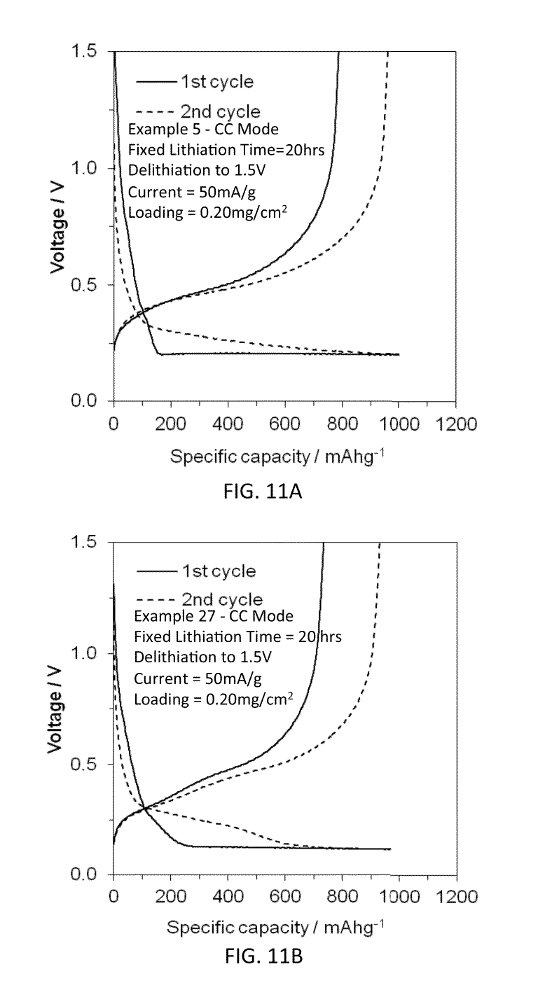

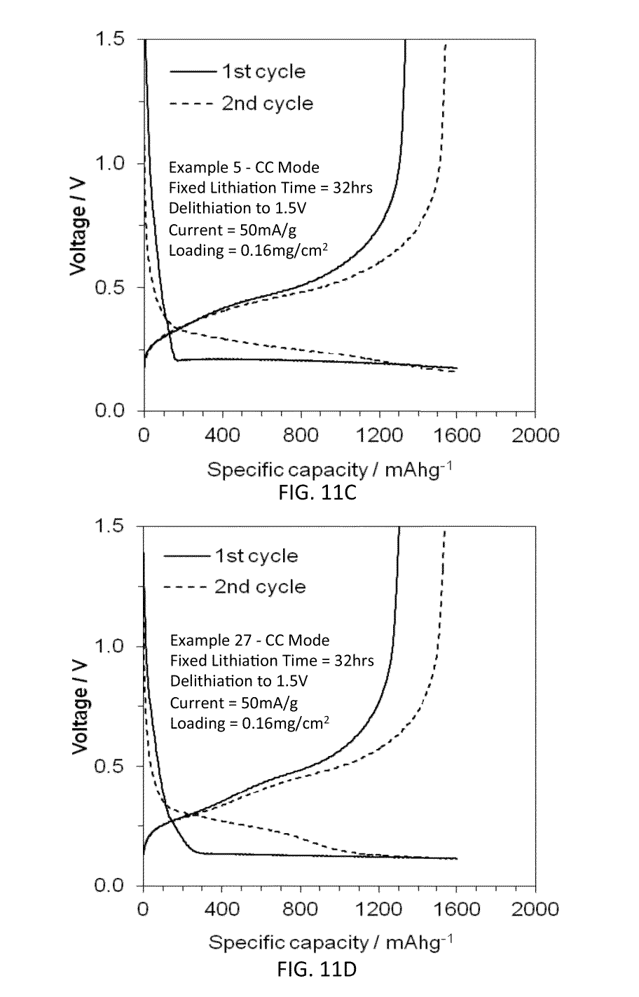

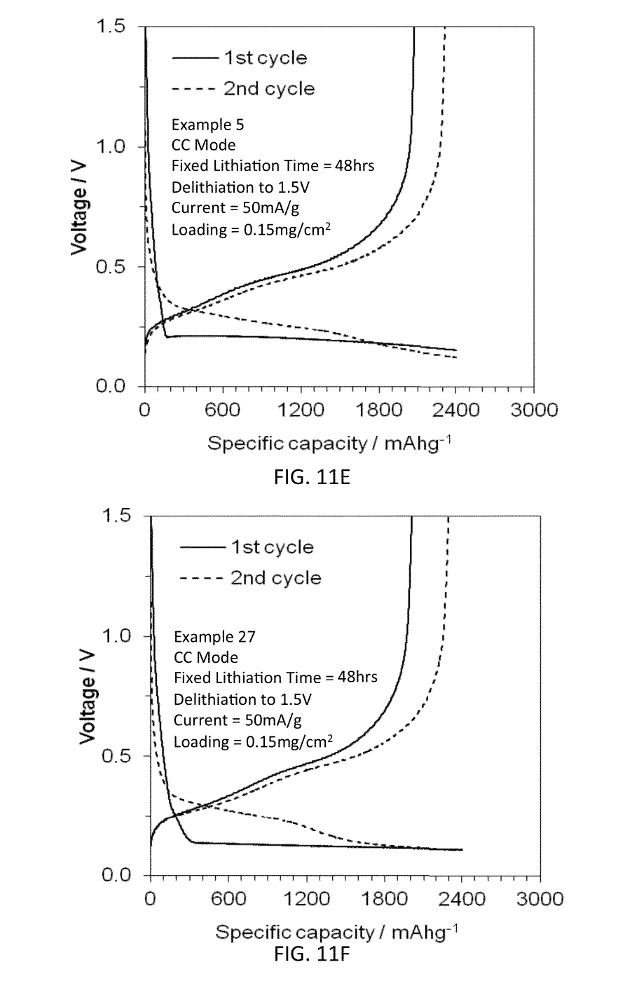

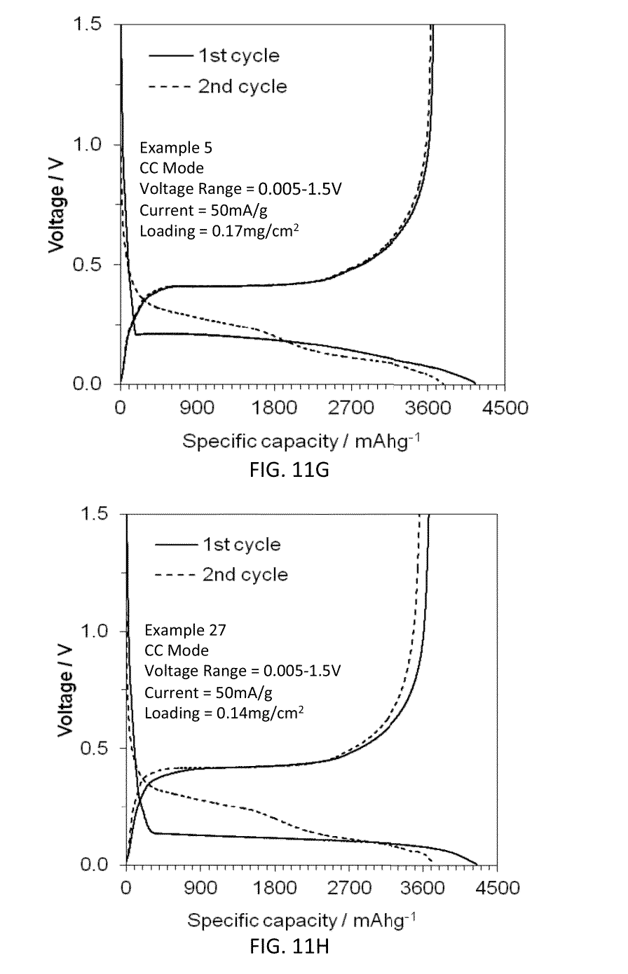

To prepare the electrodes of FIGS. 11-13, the active material, poly(acrylic acid) (Mw=450,000; Sigma Aldrich), carboxymethylcellulose sodium (MTI Corporation), and acetylene black (Denka) were put in a glass vial in a weight ratio of 70:10:5:15 (1400 mg in total). A proper amount of ultrapure water (>2000 μL) was then added to the glass vial. The aqueous slurry was mixed using a Thinky mixer and then applied onto copper foil using a bar coater. The coated copper foil was placed in an oven at 120° C. under vacuum. The working electrode (15 mm diameter) was then cut away from the coated pressed copper foil.

### Li-Ion Cell Fabrication

For FIGS. 10A-C, aluminum-laminated packages were used for cell fabrication. Lithium foil (15 mm diameter, Honjo Metal) was used as the counter electrode. A glass microfiber sheet (Watman International) was sandwiched between the working electrode and the counter electrode as a separator. The electrolyte used was 1 mol dm⁻³ LiP F₆ dissolved in a mixture of ethylene carbonate (EC) and ethyl methyl carbonate (EMC) (3:7 by vol.) (Kishida Chemical). All fabrication steps were carried out in an argon-filled glovebox.

For FIGS. 10D-I, 2032 coin cells were used for cell assembly. Lithium foil (15 mm diameter, MTI corporation) was used as the counter electrode. A polypropylene sheet (Separator, Tonnen) was sandwiched between the working electrode and the counter electrode as a separator. The electrolyte used was 1 mol dm⁻³ LiPF₆ dissolved in a mixture of ethylene carbonate (EC) and ethyl methyl carbonate (EMC) (3:7 by vol.) (Novolyte Technologies). All fabrication steps were carried out in an argon-filled glove box.

For FIGS. 14A and 14B, 2032 coin cells were used for cell assembly. LiCoO₂ based cathode (15 mm diameter, MTI corporation) and anodes from sample 18 and sample 23 were used to form full cell. A polypropylene sheet (Separator, Tonnen) was sandwiched between the cathode and anode as a separator. The electrolyte used was 1 mol dm⁻³ LiPF₆ dissolved in a mixture of ethylene carbonate (EC) and diethyl carbonate (DEC) (1:1 by wt.) (Novolyte Technologies). All fabrication steps were carried out in an argon-filled glove box.

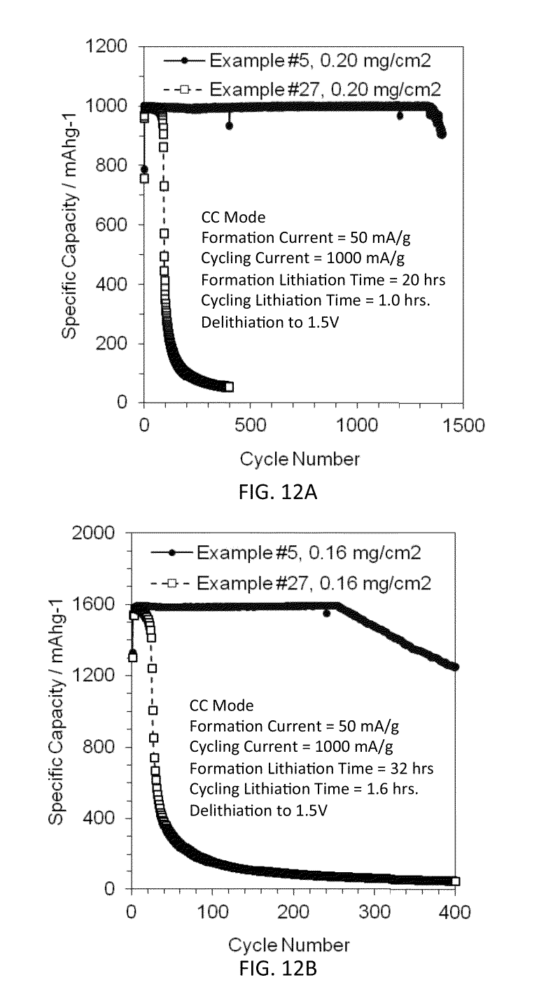

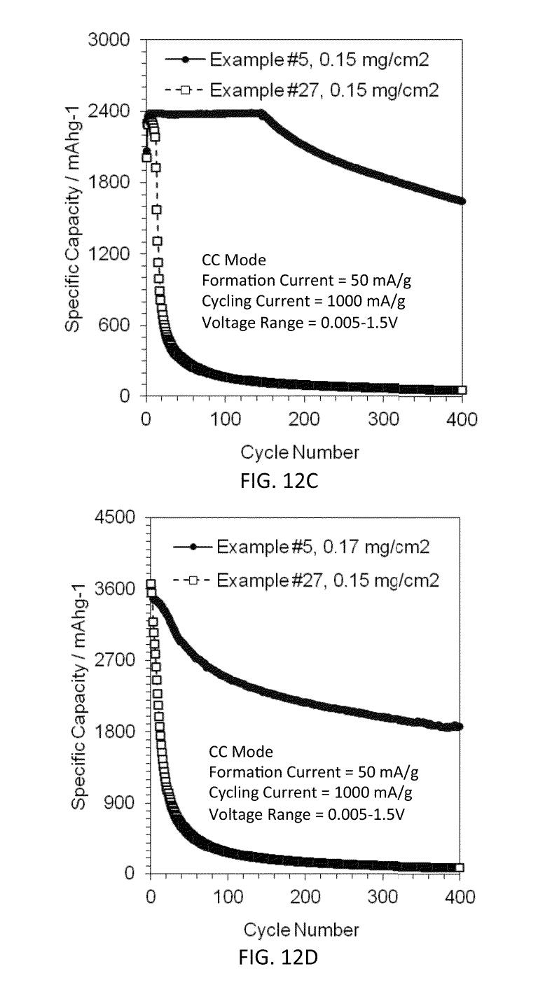

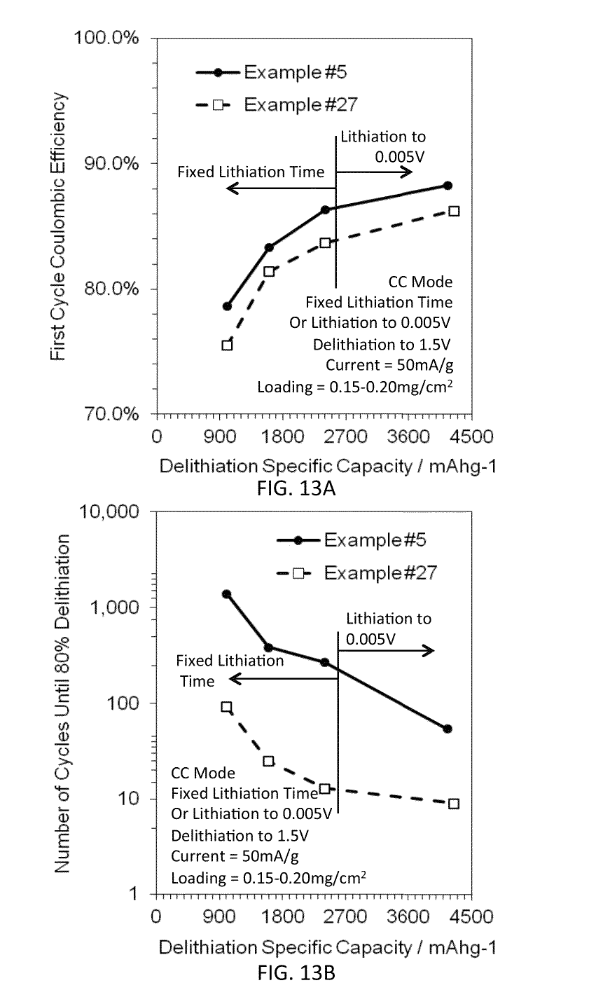

For FIGS. 11A-IH, and FIGS. 12A-D, and FIGS. 13A-B, 2032 coin cells where used for cell assembly. Lithium foil (15 mm diameter, MTI corporation) was used as the counter electrode. A polypropylene sheet (Separator, Tonnen) was sandwiched between the working electrode and the counter electrode as a separator. The electrolyte used was 1 mol dm⁻³ LiPF₆ dissolved in a mixture of ethylene carbonate (EC) and diethyl carbonate (DEC) (1:1 by vol.) (Novolyte Technologies)+10 wt. % fluoroethylene carbonate (Solvay Chemicals). All fabrication steps were carried out in an argon-filled glovebox.

### Electrochemical Lithiation/Delithiation

For FIGS. 10A-C, the lithiation was galvanostatically conducted at 120 mA g⁻¹ for 10 h in a temperature-controlled oven at 30° C. The galvanostatic delithiation to 1.5 V was then performed at 120 mA g⁻¹. Lithiation/delithiation cycling tests were performed in a way similar to that described above.

For FIGS. 10D-I, the lithiation was galvanostatically conducted at 356 mA g⁻¹ (C/10) to 0.005V. The galvanostatic delithiation to 1.5 V was then performed at 356 mA g⁻¹. Lithiation/delithiation cycling tests were performed in a way similar to that described above.

The lithiation was galvanostatically conducted at 50 mA g⁻¹ for 20 hrs. (FIGS. 11A and 11B), 32 hrs. (FIGS. 11C and 11D), 48 hrs. (FIGS. 11E and 11F), or until the voltage of the cell had decreased to 0.005V (FIGS. 11G and 11H). The galvanostatic delithiation to 1.5 V was then performed at 50 mA g⁻¹. Lithiation/delithiation cycling tests were performed in a way similar to that described above. These figures demonstrate a difference in the voltage profiles between an electrode including an electroactive material that is primary crystalline in nature (example 27) and one that is primarily non-crystalline in nature (example 5). Specifically, on the first lithiation cycle, the average voltage for example 27 is less than the average voltage of example 5; this is attributed to the non-crystalline nature of the electroactive material of example 5.

The lithiation was galvanostatically conducted at 50 mA g⁻¹ for 20 hrs. (FIG. 12A), 32 hrs. (FIG. 12B), 48 hrs. (FIG. 120),or until the voltage of the cell had decreased to 0.005V (FIG. 12D). The galvanostatic delithiation to 1.5 V was then performed at 50 mA g⁻¹. Lithiation/delithiation cycling tests were performed in a way similar to that described above. These figures demonstrate the cycle performance that is generally provided by electrodes comprising electroactive materials that exhibit primarily non-crystalline silicon (<20% crystalline), with a preferred particle size (D₅₀<about 5 microns), and a preferred morphology (spherical). In each case, the electrode formed from the silicon powder of example 5 exhibits a greater number of cycles before cell failure (i.e., when capacity is decreased to 80% of the first post-formation cycle capacity) when compared with to the electrode formed from the silicon powders of example 27.

For FIGS. 13A and 13B, the lithiation was galvanostatically conducted at 50 mA g⁻¹ for 20 hrs, 32 hrs, 48 hrs. or until the voltage of the cell had decreased to 0.005V. The galvanostatic delithiation to 1.5 V was then performed at 50 mA g⁻¹. Lithiation/delithiation cycling tests were performed in a way similar to that described above. These figures demonstrate: 1) the general finding that electrodes including electroactive materials comprising primarily non-crystalline silicon possess improved first cycle Coulombic efficiency when compared with electrodes utilizing primarily crystalline electroactive materials (FIG. 13A); and 2) that the cycle-life provided by electrodes comprising electroactive materials based on primarily non-crystalline silicon (<20% crystalline Si), with a preferred particle size (D₅₀<5 micrometers), and a preferred morphology (spherical) is better than that provided by electrodes comprising electroactive materials based on primarily of crystalline or polycrystalline silicon (>50% crystalline Si) (FIG. 13B).

A summary of the initial cycle results is provided in Table 5 and in FIGS. 11A-11I. The performance of the silicon anodes is believed to be comparable to the performance achieved from currently used graphite anodes.

TABLE 5
Summary of Initial Cycle Results

| | |
|---|---|
| 1st cycle | 2nd cycle |

| | | | Coulombic | | | Coulombic | Electrode | Electrode |
|---|---|---|---|---|---|---|---|---|
| | Lithiation | Delithiation | efficiency | Lithiation | Delithiation | efficiency | density | thickness |
| Ex. # | [mAh/g] | mAh/g] | [%] | [mAh/g] | [mAh/g] | [%] | [g/cm³] | [μm] |
| 4 | 1202 | 992 | 82.6 | 1202 | 1170 | 97.3 | 0.65 | 32 |
| 5 | 1200 | 963 | 80.3 | 1200 | 1162 | 96.9 | 0.82 | 53 |
| 14 | 1199 | 1082 | 90.2 | 1199 | 1173 | 97.8 | 0.97 | 26 |
| 18 | 3032 | 2870 | 94.7 | 2705 | 2628 | 97.2 | 1.1 | 43 |
| 19 | 3128 | 2924 | 93.5 | 2918 | 2723 | 93.3 | 1.1 | 42 |
| 20 | 3070 | 2909 | 94.7 | 2919 | 2692 | 92.2 | 1.1 | 41 |
| 21 | 3187 | 2960 | 92.9 | 2898 | 2758 | 95.2 | 1.0 | 46 |
| 22 | 3370 | 3150 | 93.5 | 3115 | 2987 | 95.9 | 1.0 | 38 |
| 23 | 3039 | 2829 | 93.1 | 2877 | 2789 | 96.9 | 1.0 | 40 |

A summary of the electrochemical tests in coin cells is provided here. Three different evaluations have been performed on electrodes formed from Si powders. First, capacity limited test conditions were applied to the electrodes of examples 4, 5 and 14, and the first lithiation capacities were limited to about 1200 mAh/g independent of the amount of crystalline Si in the samples. However, the delithiation capacity of the sample electrodes varied with the amount of crystalline Si present in the electroactive material. The electroactive material of example 5 has about 1 wt. % crystalline Si and that of example 14 has about 10 wt. % crystalline Si, based on the PDF analysis. With a higher crystalline content of the electroactive material, the electrode of example 14 showed 90% first cycle Coulombic efficiency (CE), while the electrodes of example 4 (substantially entirely non-crystalline Si) and example 5 (about 1 wt % crystalline Si) showed 80% first cycle CE. However, no difference was observed from second lithiation/delithiation, which suggests that the amount of crystalline Si content of the electroactive material is critical for the first cycle CE.

The second test condition is constant current lithiation to 0.005V where a lithium silicide phase, Li_{3.75}Si, may be formed. This test condition was applied to electrodes comprising electroactive materials based on substantially entirely non-crystalline Si (18 to 21) and on partly crystalline Si (22 to 23). The first cycle lithiation capacity from all of the electrodes tested under this condition is above 3000 mAh/g with about 93-95% first cycle CE. Among the electrode samples, example 22, which comprises an electroactive material including 5 wt. % crystalline Si based on the PDF analysis, shows the highest first cycle lithiation/deliathiation capacity. This result is very similar to the result from the first test condition and suggests that using an electroactive material including both crystalline Si and non-crystalline Si may improve battery performance.

The third test was performed in a full coin cell format, as depicted in FIG. 14. This test shows the actual discharge voltage profile which is important for practical application of silicon powders introduced here. The average working voltage of a Li ion battery is known as 3.7V with working window in 3.0V-4.2V. As shown in FIG. 14, electrodes comprising electroactive materials based substantially entirely on non-crystalline Si (Ex. 18 in FIG. 14A) or including both crystalline and non-crystalline Si (Ex. 22 in FIG. 14B) show substantially the same operating voltage windows and average working voltage of about 3.7 V.

As shown in FIGS. 12A through 12D, the cycle life of Si powder-based half cell has been demonstrated under different conditions. The advantage of utilizing an electrode comprising an electroactive material containing both non-crystalline and crystalline Si powders (e.g., examples 5, 14, 22 and 23) has been demonstrated in terms of a CE over 93% and a discharge capacity over 3000 mAh/g.

FIG. 14C also shows cycle performance of the electrode of Example 23 with a LCO cathode in full cell format. Different from an electrode based on purely crystalline Si powder, the electrode of example 23 shows good cycle performance, which suggests that good anode materials may be formed from silicon powders comprising crystalline Si and non-crystalline Si.

Although the present invention has been described in considerable detail with reference to certain embodiments thereof, other embodiments are possible without departing from the present invention. The spirit and scope of the appended claims should not be limited, therefore, to the description of the preferred embodiments included here. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

What is claimed is:

1. A method of controlling the crystallinity of a silicon powder, the method comprising:
heating a reactor to a temperature of no more than 650° C.;
flowing a feed gas comprising silane and a carrier gas into the reactor at a molar gas flux of from about 5 mol/min/m² to about 25 mol/min/m²; and
decomposing the silane to form a silicon powder having a controlled crystallinity and comprising non-crystalline silicon.

2. The method of claim 1, wherein the silicon powder further comprises crystalline silicon at a concentration of no more than about 20 wt. %.

3. The method of claim 1, wherein the molar gas flux is from about 8 mol/min/m² to about 21 mol/min/m².

4. The method of claim 1, wherein the temperature is from about 450° C. to about 620° C.

5. The method of claim 1, wherein the carrier gas is selected from the group consisting of argon, hydrogen and helium.

6. The method of claim 1, wherein the silane has a concentration in the feed gas of between about 0.2 and about 0.8 mole fraction.

7. The method of claim 1, wherein an internal reactor pressure of about 2 atm or less is maintained during the flowing of the feed gas into the reactor.

8. The method of claim 7, wherein the internal reactor pressure is at least about 1 atm.

9. The method of claim 7, wherein the internal reactor pressure is at least about 0.5 atm and less than 1 atm.

10. The method of claim 1, wherein the temperature is greater than about 525° C.

11. A method of controlling the crystallinity of a silicon powder, the method comprising:
flowing a feed gas comprising silane and a carrier gas into a heated reactor at a molar gas flux of from about 5 mol/min/m² to about 25 mol/min/m²;
maintaining an internal reactor pressure of about 2 atm or less during the flowing of the feed gas into the heated reactor; and
decomposing the silane to form a silicon powder having a controlled crystallinity and comprising non-crystalline silicon.

12. The method of claim 11, wherein the silicon powder further comprises crystalline silicon at a concentration of no more than about 20 wt. %.

13. The method of claim 11, wherein the molar gas flux is from about 8 mol/min/m² to about 21 mol/min/m².

14. The method of claim 11, wherein the heated reactor is heated to a temperature of no more than 650° C.

15. The method of claim 14, wherein the temperature is from about 450° C. to about 620° C.
